(19) United States
(12) Patent Application Publication
(10) Pub. No.: US 2026/0112808 A1
(43) Pub. Date: Apr. 23, 2026

(54) ANTENNA ASSEMBLY, COMMUNICATION DEVICE, AND VEHICLE

(71) Applicant: Huawei Technologies Co., Ltd., Shenzhen (CN)

(72) Inventors: Ruiyang Li, Shenzhen (CN); Qing Liu, Shenzhen (CN); Qun Guo, Dongguan (CN)

(21) Appl. No.: 19/426,275

(22) Filed: Dec. 19, 2025

Related U.S. Application Data
(63) Continuation of application No. PCT/CN2024/072624, filed on Jan. 16, 2024.

(30) Foreign Application Priority Data
Jun. 20, 2023 (CN) 202310743023.0

(51) Int. Cl. H01Q 1/32; H01Q 1/48; H01Q 9/04; H01Q 21/06

(52) U.S. Cl. CPC H01Q 1/3275; H01Q 1/48; H01Q 9/0421; H01Q 9/0428; H01Q 21/065

(57) ABSTRACT

An antenna assembly, including a substrate having conductive grounding layer disposed on the substrate, a first antenna array disposed on the conductive grounding layer, where the first antenna array has a plurality of first antenna stubs, a plurality of first capacitors, where each first antenna stub of the plurality of first antenna stubs has a first feed end and a first open end, and each first capacitor is coupled to the first feed end of one first antenna stub, and a plurality of second capacitors, where the first open end of each first antenna stub is coupled to the conductive grounding layer through one second capacitor of the plurality of second capacitors.

### CROSS-REFERENCE TO RELATED APPLICATIONS

This application is a continuation of International Application No. PCT/CN2024/072624, filed on Jan. 16, 2024, which claims priority to Chinese Patent Application No. 202310743023.0, filed on Jun. 20, 2023. The disclosures of the aforementioned applications are hereby incorporated by reference in their entireties.

### TECHNICAL FIELD

Embodiments of this application relate to the field of communication technologies, and in particular, to an antenna assembly, a communication device, and a vehicle.

### BACKGROUND

An antenna assembly is usually disposed on a device like a vehicle or a ship. The antenna assembly may send and receive signals, to implement functions such as positioning or wireless communication. In a related technology, the antenna assembly includes a ground plane and an antenna stub disposed on a side of the ground plane. A feed point and a ground point are disposed on the antenna stub. The ground point is electrically connected to the metal ground plane for grounding, and the antenna stub is fed through the feed point. In the related technology, the antenna assembly has a low gain and poor communication performance.

### SUMMARY

Embodiments of this application provide an antenna assembly, a communication device, and a vehicle, to increase a gain of the antenna assembly.

According to a first aspect, an embodiment of this application provides an antenna assembly, including a substrate, a first antenna array, and a first capacitor. A conductive grounding layer is disposed on the substrate. The first antenna array is disposed on the conductive grounding layer. The first antenna array includes a plurality of first antenna stubs. There is a first preset included angle between the substrate and a plane on which each first antenna stub is located. There are a plurality of first capacitors. Each of the plurality of first antenna stubs includes a first feed end and a first open end. Each first capacitor is coupled to the first feed end of one first antenna stub.

In this way, the first capacitor may adjust current distribution on the first antenna stub, so that a current on the first antenna stub is a codirectional current, and the current on the first antenna stub gradually increases from the first feed end to a middle part of the first antenna stub in an extension direction. In addition, the current on the first antenna stub may also gradually increase from the first open end to the middle part of the first antenna stub in the extension direction. In other words, there is a current strong point is on the middle part of the first antenna stub, so that the first antenna stub operates in a differential mode, and the middle part of the first antenna stub is mainly used for signal transmission and reception. A strong current on the middle part of the first antenna stub can increase gains of the first antenna stub and the antenna assembly, so that performance of the antenna assembly is improved.

In some embodiments that may include the foregoing embodiment, a capacitance value of the first capacitor may range from 0.1 pF to 0.5 pF. For example, the capacitance value of the first capacitor may be 0.1 pF, 0.25 pF, 0.5 pF, or the like. A resonance frequency of the first antenna stub gradually decreases as the capacitance value of the first capacitor increases. The capacitance value of the first capacitor ranges from 0.1 pF to 0.5 pF, so that an excessively low resonance frequency of the first antenna stub due to an excessively large capacitance value of the first capacitor can be avoided while it is ensured that the first antenna stub operates in the differential mode.

In some embodiments that may include the foregoing embodiment, the antenna assembly further includes a second capacitor. There are a plurality of second capacitors. The first open end of each first antenna stub is electrically coupled to the conductive grounding layer through one second capacitor. In this way, a resonance frequency of the first antenna stub connected to the second capacitor may be reduced through the second capacitor, so that a size (a length in the extension direction) of the first antenna stub can be reduced, to implement miniaturization of the antenna assembly.

In some embodiments that may include the foregoing embodiment, the first feed end and the first open end are two opposite ends of the first antenna stub in an extension direction of the first antenna stub.

In some embodiments that may include the foregoing embodiment, a current, between the first feed end and the first open end, on the first antenna stub is a codirectional current, the current on the first antenna stub gradually increases from the first feed end to a middle part of the first antenna stub in the extension direction, and the current on the first antenna stub gradually increases from the first open end to the middle part of the first antenna stub in the extension direction. In this way, the first antenna stub operates in the differential mode, and the middle part of the first antenna stub is mainly used for signal transmission and reception, so that gains of the first antenna stub and the antenna assembly can be increased, and performance of the antenna assembly is further improved.

In some embodiments that may include the foregoing embodiment, a capacitance value of the second capacitor may range from 0.1 pF to 0.5 pF. For example, the capacitance value of the second capacitor may be 0.1 pF, 0.25 pF, 0.5 pF, or the like. It may be understood that if the capacitance value of the second capacitor is excessively large, impedance matching of the first antenna stub is difficult. The capacitance value of the second capacitor ranges from 0.1 pF to 0.5 pF, so that the impedance matching difficulty of the first antenna stub is reduced while it is ensured that the first antenna stub operates in the DM mode and the size of the first antenna stub is reduced by using the second capacitor.

In some embodiments that may include the foregoing embodiment, the antenna assembly further includes an inductor. There are a plurality of inductors. One end of each first capacitor is electrically connected to the first feed end of one first antenna stub, and the other end of each first capacitor is electrically connected to one inductor. In this way, a resonance frequency of a first antenna stub corresponding to the inductor can be reduced through the inductor, so that the size of the first antenna stub can be reduced, to implement miniaturization of the antenna assembly.

In some embodiments that may include the foregoing embodiment, an inductance value of the inductor may be 10 nH to 15 nH (10 nH, 12.5 nH, 15 nH, or the like), to avoid an excessively large or small inductance value of the inductor while it is ensured that the resonance frequency of the first antenna stub is reduced to reduce the size of the first antenna stub.

In some embodiments that may include the foregoing embodiment, the antenna assembly further includes a first feed source. The first feed end of each of the plurality of first antenna stubs is coupled to the first feed source, and the first antenna stub is configured to receive a signal of the first feed source for radiation on a first operating frequency band. In this way, the first feed source may radiate a signal to the first antenna stub.

In some embodiments that may include the foregoing embodiment, signals received by first feed ends of adjacent first antenna stubs have an equal phase difference, for the first antenna array to generate a circular polarization signal. In this way, the first antenna array can receive a signal in any polarization direction. This improves universality of the antenna assembly.

In some embodiments that may include the foregoing embodiment, the antenna assembly further includes a second feed source, and a second antenna array. The second antenna array includes a plurality of second antenna stubs, and there is a second preset included angle between the substrate and a plane on which each second antenna stub is located. Each of the plurality of second antenna stubs includes a second feed end, the plurality of second feed ends are all coupled to the second feed source, and the second antenna stub is configured to receive a signal of the second feed source for radiation on a second operating frequency band. A frequency of the first operating frequency band is different from a frequency of the second operating frequency band. In this way, resonance frequencies excited by the first antenna array and the second antenna array are different, in other words, frequency bands covered by the first antenna array and the second antenna array are different, so that a coverage frequency of the antenna assembly is increased and a bandwidth of the antenna assembly is increased.

In some embodiments that may include the foregoing embodiment, the antenna assembly further includes a third capacitor. There are a plurality of third capacitors. The second feed end of each second antenna stub is coupled to one third capacitor. In this way, the third capacitor may adjust current distribution on the second antenna stub, so that a current on the second antenna stub is a codirectional current, and the current on the second antenna stub gradually increases from the second feed end to a middle part or an approximately middle part of the second antenna stub in an extension direction. In addition, the current on the second antenna stub may also gradually increase from a second open end to the middle part or the approximately middle part of the second antenna stub in the extension direction, so that the second antenna stub operates in the differential mode. In this way, a bandwidth of the second antenna stub and the entire antenna assembly is increased, and performance of the antenna assembly is improved.

In some embodiments that may include the foregoing embodiment, a capacitance value of the third capacitor may range from 0.1 pF to 0.5 pF. For example, the capacitance value of the third capacitor may be 0.1 pF, 0.25 pF, 0.5 pF, or the like. A resonance frequency of the second antenna stub gradually decreases as the capacitance value of the third capacitor increases. The capacitance value of the third capacitor ranges from 0.1 pF to 0.5 pF, so that an excessively low resonance frequency of the second antenna stub due to an excessively large capacitance value of the third capacitor can be avoided while it is ensured that the second antenna stub operates in the differential mode.

In some embodiments that may include the foregoing embodiment, the antenna assembly further includes a fourth capacitor. There are a plurality of fourth capacitors, each of the plurality of second antenna stubs further includes a second open end, and the second open end of each second antenna stub is coupled to the conductive grounding layer through one fourth capacitor. In this way, a resonance frequency of the second antenna stub connected to the fourth capacitor can be reduced through the fourth capacitor, so that a size (a length in the extension direction) of the second antenna stub can be reduced, to implement miniaturization of the antenna assembly.

In some embodiments that may include the foregoing embodiment, a capacitance value of the fourth capacitor may range from 0.1 pF to 0.5 pF. For example, the capacitance value of the fourth capacitor may be 0.1 pF, 0.25 pF, 0.5 pF, or the like. It may be understood that if the capacitance value of the fourth capacitor is excessively large, impedance matching of the second antenna stub is difficult. The capacitance value of the fourth capacitor ranges from 0.1 pF to 0.5 pF, so that the impedance matching difficulty of the second antenna stub is reduced while it is ensured that the second antenna stub operates in the DM mode and the size of the second antenna stub is reduced through the fourth capacitor.

In some embodiments that may include the foregoing embodiment, the second feed end and the second open end are two opposite ends of the second antenna stub in an extension direction.

In some embodiments that may include the foregoing embodiment, a current, between the second feed end and the second open end, on the second antenna stub is a codirectional current, the current on the second antenna stub gradually increases from the second feed end to a middle part of the second antenna stub in the extension direction, and the current on the second antenna stub gradually increases from the second open end to the middle part of the second antenna stub in the extension direction. In this way, the second antenna stub operates in the differential mode, so that a bandwidth of the second antenna stub and the entire antenna assembly is increased, and performance of the antenna assembly is improved.

In some embodiments that may include the foregoing embodiment, an inductor may also be disposed between a second feed device and the third capacitor. In other words, the second feed device is connected to the third capacitor through the inductor. The resonance frequency of the second antenna stub can be reduced through the inductor, to reduce a size of the second antenna stub. An inductance value of the inductor may be 10 nH to 15 nH (10 nH, 12.5 nH, 15 nH, or the like), to avoid an excessively large or small inductance value of the inductor while it is ensured that the resonance frequency of the second antenna stub is reduced to reduce the size of the second antenna stub.

In some embodiments that may include the foregoing embodiment, the first antenna array further includes a first dielectric pillar. The first dielectric pillar is disposed on the substrate, and the plurality of first antenna stubs are disposed on a side wall of the first dielectric pillar. In this way, the first antenna stub may be fastened and supported through the first dielectric pillar, to improve structural stability of the antenna assembly.

In some embodiments that may include the foregoing embodiment, a first accommodation hole is provided on the first dielectric pillar, a geometric center line of the first dielectric pillar is collinear with a geometric center line of the first accommodation hole, and the second antenna array is disposed in the first accommodation hole. In this way, the second antenna array can be prevented from occupying space, to reduce a volume of the antenna assembly. This facilitates miniaturization of the antenna assembly.

In some embodiments that may include the foregoing embodiment, the second antenna array further includes a second dielectric pillar. The second dielectric pillar is disposed in the first accommodation hole, a geometric center line of the second dielectric pillar is collinear with the geometric center line of the first dielectric pillar, and the plurality of second antenna stubs are disposed on a side wall of the second dielectric pillar. The second antenna stub may be fastened and supported through the second dielectric pillar, to improve structural stability of the antenna assembly.

In some embodiments that may include the foregoing embodiment, a second accommodation hole is provided on the second dielectric pillar, and a center line of the second accommodation hole is collinear with a preset straight line. In this way, a mass of the second dielectric pillar can be reduced, to implement lightweight of the antenna assembly.

In some embodiments that may include the foregoing embodiment, each second antenna stub corresponds to one first antenna stub. In the first antenna stub and the second antenna stub that correspond to each other, the first feed end is disposed closer to the second feed end than the first open end, and the first open end is disposed closer to the second open end than the second feed end. In this way, currents on the first antenna stub and the second antenna stub that correspond to each other may be codirectional currents.

In some embodiments that may include the foregoing embodiment, in two adjacent first antenna stubs, a first open end of a preceding first antenna stub is disposed close to a first feed end of a following first antenna stub, and in two adjacent second antenna stubs, a second open end of a preceding second antenna stub is disposed close to a second feed end of a following second antenna stub. In this way, first antenna stubs are sequentially disposed end to end in a direction surrounding the geometric center line of the first dielectric pillar, and a current on the first antenna array is disposed around a geometric center of the first dielectric pillar (the current on the first antenna array is set clockwise or counterclockwise around the geometric center of the first dielectric pillar). Similarly, the second antenna stubs are sequentially disposed end to end, the second antenna stubs are sequentially disposed end to end in the direction surrounding the geometric center line of the first dielectric pillar, and a current on the second antenna array is disposed around the geometric center of the first dielectric pillar (the current on the second antenna array is set clockwise or counterclockwise around the geometric center of the first dielectric pillar).

In some embodiments that may include the foregoing embodiment, each second antenna stub corresponds to one first antenna stub, and a minimum distance between the first antenna stub and the second antenna stub that correspond to each other is greater than or equal to 1 mm. In this way, an axial ratio and resonance of each of the first antenna stub and the second antenna stub are not affected by an excessively small distance between first antenna stub and the second antenna stub that correspond to each other.

In some embodiments that may include the foregoing embodiment, the first antenna stubs are centrosymmetric relative to the geometric center line of the first dielectric pillar, and the second antenna stubs are centrosymmetric relative to the geometric center line of the second dielectric pillar.

In some embodiments that may include the foregoing embodiment, the frequency of the first operating frequency band is greater than the frequency of the second operating frequency band. In this way, the first antenna array located on the outer side has a higher operating frequency, is less affected by low-frequency blocking interference, and has wider radiation space. Therefore, high-frequency performance can be improved, and performance of the antenna assembly can be improved.

In some embodiments that may include the foregoing embodiment, each second antenna stub is disposed in the first accommodation hole, and planes on which the second antenna stubs are located intersect at the geometric center line of the first dielectric pillar. In this way, each second antenna stub extends toward a middle part of the first accommodation hole, so that a distance between the second antenna stub and the side wall of the first dielectric pillar can be increased, a distance between the first antenna stub and the second antenna stub is increased, and isolation between the first antenna stub and the second antenna stub is further improved.

In some embodiments that may include the foregoing embodiment, the second antenna array includes a plurality of dielectric plates disposed in the first accommodation hole, and each second antenna stub is disposed on one dielectric plate. Each second antenna stub may be supported and fastened through the dielectric plate.

In some embodiments that may include the foregoing embodiment, each second antenna stub corresponds to one first antenna stub. In the second antenna stub and the first antenna stub that correspond to each other, the second feed end of the second antenna stub is disposed away from the first antenna stub. In this way, a distance between the second feed end and the corresponding first antenna stub can be increased, to further improve isolation between the first antenna stub and the second antenna stub.

In some embodiments that may include the foregoing embodiment, the first operating frequency band is less than the second operating frequency band. Each second antenna stub extends toward the middle part of the first accommodation hole, so that isolation between the first antenna stub and the second antenna stub is further improved. Therefore, performance of the antenna assembly can be ensured.

In some embodiments that may include the foregoing embodiment, a difference between the frequency of the first operating frequency band and the frequency of the second operating frequency band is greater than or equal to 180 MHz.

In some embodiments that may include the foregoing embodiment, the antenna assembly further includes a conductive ring. The conductive ring is disposed on a side that is of the first antenna array and the second antenna array and that is away from the substrate, and a distance between the conductive ring and the first antenna stub is less than or equal to 11 mm. A direction of an induced current in the conductive ring is the same as directions of currents on the first antenna stub and the second antenna stub. In far-field performance, the conductive ring may have a codirectional superposition effect, to increase gains of the first antenna array and the second antenna array. In addition, a circularly polarized electromagnetic wave radiated by the conductive ring is rotated in a same direction as circularly polarized electromagnetic waves radiated by the first antenna array and the second antenna array, and the current on the conductive ring and currents on the first antenna array and the second antenna array have a same phase change and polarization. In this way, circular polarization radiation of the first antenna array and the second antenna array on the rectangular conductive grounding layer is purer, and deterioration of circular polarization radiation of the first antenna array and the second antenna array caused by an asymmetric environment is corrected to a specific extent. Therefore, an axial ratio of the first antenna array and an axial ratio of the second antenna array can be reduced.

It may be understood that in an implementation in which the conductive ring is disposed on a side that is of the first antenna array and that is away from the substrate (that is, the conductive ring is opposite to the first antenna array), the conductive ring mainly improves performance of the first antenna array. In an implementation in which the conductive ring is disposed on a side that is of the second antenna array and that is away from the substrate (that is, the conductive ring is opposite to the second antenna array), the conductive ring mainly improves performance of the second antenna array.

In some embodiments that may include the foregoing embodiment, the antenna assembly further includes a dielectric slab. The dielectric slab and the substrate are parallel to and spaced from each other, and the conductive ring is disposed on the dielectric slab. In this way, the conductive ring may be supported and fastened through the dielectric slab.

In some embodiments that may include the foregoing embodiment, the antenna assembly is disposed on a telematics box, and the telematics box may include a housing. A mounting cavity is enclosed by the housing, and the substrate, the first antenna array, and the second antenna array are all disposed in the mounting cavity. Correspondingly, the dielectric slab may also be disposed in the mounting cavity and connected to the housing, to fasten the dielectric slab. Certainly, in another implementation, the conductive ring may be directly disposed on the housing. In this case, the dielectric slab does not need to be disposed, to reduce a volume and a mass of the telematics box.

In some embodiments that may include the foregoing embodiment, the first antenna array is located at a geometric center of the conductive grounding layer. In this way, the antenna assembly is located in a symmetrical environment, to improve a circular polarization effect of the antenna assembly.

In some embodiments that may include the foregoing embodiment, the first antenna array and the geometric center of the conductive grounding layer are spaced from each other. In this way, the antenna assembly has an irregular shape, and can adapt to irregular mounting space, to adapt to mounting space of another device. This improves performance of the antenna assembly in a non-ideal environment. In addition, because each first antenna stub operates in a differential mode, radiation energy of the first antenna stub is strong, and is less affected by an asymmetric switching environment, so that a circular polarization effect of the antenna assembly can still be ensured.

In some embodiments that may include the foregoing embodiment, the antenna assembly further includes a plurality of filter capacitors, and the second feed end of each second antenna stub is electrically coupled to the first feed end of one first antenna stub through one filter capacitor. In this way, the first antenna stub and the second antenna stub may be separately fed through the first feed end. Correspondingly, only a first feed device may be disposed to implement feeding of the first antenna stub and the second antenna stub, and the second feed device does not need to be disposed, so that a system structure can be simplified.

In some embodiments that may include the foregoing embodiment, a capacitance value of the filter capacitor may be 0.1 pF to 1 pF (for example, 0.1 pF, 0.5 pF, or 1 pF).

In some embodiments that may include the foregoing embodiment, the first antenna array further includes a first dielectric pillar. The first dielectric pillar is disposed on the substrate, and the plurality of first antenna stubs and the plurality of second antenna stubs are all disposed on the side wall of the first dielectric pillar. In this way, compactness of the antenna assembly can be improved, and a volume and a mass of the antenna assembly can be further reduced.

In some embodiments that may include the foregoing embodiment, the antenna assembly further includes a conductive plate. The conductive plate and the substrate are parallel to and spaced from each other. The first antenna array is located between the conductive plate and the substrate. The conductive plate and the first antenna array are spaced from each other. A projection of the conductive plate on the substrate is located in an area enclosed by projections of the plurality of first antenna stubs on the substrate. A plurality of slots are provided on the conductive plate, each slot corresponds to a position of one first antenna stub, and the first antenna stub is configured to couple a signal to the conductive plate. The slot extends on the conductive plate, so that the slot and the conductive plate around the slot form a slot antenna. Slot antennas are disposed around a preset straight line at equal central angles. Each slot corresponds to a position of one first antenna stub, and the first antenna stub is configured to couple a signal to the conductive plate. In other words, each first antenna stub may couple a signal to one slot antenna corresponding to the first antenna stub.

In this way, the slot antenna in the conductive plate and a corresponding first antenna stub may be fed through a same first feed end. Correspondingly, the slot antenna and the first antenna stub may be fed through only the first feed device, and no second feed device needs to be disposed. This simplifies a system structure.

According to a second aspect, an embodiment of this application further provides a communication device, including a housing and the antenna assembly in any one of the foregoing embodiments. A mounting cavity is enclosed by the housing, and the antenna assembly is disposed in the mounting cavity.

The communication device provided in this embodiment of this application includes the antenna assembly in any one of the foregoing embodiments. Therefore, the communication device and the antenna assembly can resolve a same technical problem and achieve a same technical effect.

According to a third aspect, an embodiment of this application further provides a vehicle, including a vehicle body and the communication device described above. The communication device is disposed on the vehicle body.

The vehicle provided in this embodiment of this application includes the communication device in any one of the foregoing embodiments. Therefore, the vehicle and the communication device can resolve a same technical problem and achieve a same technical effect.

### BRIEF DESCRIPTION OF THE DRAWINGS

FIG. 1 is a diagram 1 of an assembling structure of an antenna assembly according to an embodiment of this application;

FIG. 2 is a diagram 1 of a structure of a first antenna stub in an antenna assembly according to an embodiment of this application;

FIG. 3 is a diagram 2 of a structure of a first antenna stub in an antenna assembly according to an embodiment of this application;

FIG. 4 is an exploded view 1 of an antenna assembly according to an embodiment of this application;

FIG. 5 is a distribution diagram 1 of currents on a first antenna stub in an antenna assembly according to an embodiment of this application;

FIG. 6 is a diagram 1 of a structure of a second antenna stub in an antenna assembly according to an embodiment of this application;

FIG. 7 is a feed phase diagram of a first antenna stub and a second antenna stub in an antenna assembly according to an embodiment of this application;

FIG. 8 is a distribution diagram 1 of currents on a second antenna stub in an antenna assembly according to an embodiment of this application;

FIG. 9 is a radio frequency block diagram of a first antenna array in an antenna assembly according to an embodiment of this application;

FIG. 10 is an active S11 curve diagram 1 of an antenna assembly according to an embodiment of this application;

FIG. 11 is a diagram 2 of an assembling structure of an antenna assembly according to an embodiment of this application;

FIG. 12 is a gain diagram 1 of a first antenna array and a second antenna array in an antenna assembly within ±30° in a zenith direction according to an embodiment of this application;

FIG. 13 is an axial ratio diagram 1 of a first antenna array and a second antenna array in an antenna assembly in a zenith direction according to an embodiment of this application;

FIG. 14 is a gain diagram 2 of a first antenna array and a second antenna array in an antenna assembly within ±30° in a zenith direction according to an embodiment of this application;

FIG. 15 is a maximum axial ratio diagram of a first antenna array and a second antenna array in an antenna assembly in a zenith direction and within ±30° in the zenith direction according to an embodiment of this application;

FIG. 16 is a diagram of a direction of an induced current in a conductive ring and directions of currents on a first antenna stub and a second antenna stub in an antenna assembly according to an embodiment of this application;

FIG. 17 is a distribution diagram of currents on a conductive ring in an antenna assembly according to an embodiment of this application;

FIG. 18 is a comparison diagram of gains before and after a conductive ring is disposed in an antenna assembly according to an embodiment of this application;

FIG. 19 is a comparison diagram of axial ratios in a zenith direction before and after a conductive ring is disposed in an antenna assembly according to an embodiment of this application;

FIG. 20 is a comparison diagram of maximum axial ratios within ±30° in a zenith direction before and after a conductive ring is disposed in an antenna assembly according to an embodiment of this application;

FIG. 21 is an exploded view 2 of an antenna assembly according to an embodiment of this application;

FIG. 22 is a diagram 3 of an assembling structure of an antenna assembly according to an embodiment of this application;

FIG. 23 is a diagram 3 of a structure of a first antenna stub in an antenna assembly according to an embodiment of this application;

FIG. 24 is a distribution diagram 2 of currents on a first antenna stub in an antenna assembly according to an embodiment of this application;

FIG. 25 is a diagram 2 of a structure of a second antenna stub in an antenna assembly according to an embodiment of this application;

FIG. 26 is a distribution diagram 2 of currents on a second antenna stub in an antenna assembly according to an embodiment of this application;

FIG. 27 is an active S11 curve diagram 2 of an antenna assembly according to an embodiment of this application;

FIG. 28 is a diagram 4 of a structure of an antenna assembly according to an embodiment of this application;

FIG. 29 is a gain diagram 1 of a first antenna array and a second antenna array in an antenna assembly according to an embodiment of this application;

FIG. 30 is an axial ratio diagram 2 of a first antenna array and a second antenna array in an antenna assembly in a zenith direction according to an embodiment of this application;

FIG. 31 is a maximum axial ratio diagram 1 of a first antenna array and a second antenna array in an antenna assembly within ±30° according to an embodiment of this application;

FIG. 32 is a diagram 5 of a structure of an antenna assembly according to an embodiment of this application;

FIG. 33 is a diagram of structures of a first antenna stub and a second antenna stub in an antenna assembly according to an embodiment of this application;

FIG. 34 is a distribution diagram of currents in an antenna assembly when a first antenna stub is fed through a first feed end according to an embodiment of this application;

FIG. 35 is a distribution diagram of currents in an antenna assembly when a second antenna stub is fed through a first feed end according to an embodiment of this application;

FIG. 36 is an active S11 curve diagram 3 of an antenna assembly according to an embodiment of this application;

FIG. 37 is a gain diagram 2 of a first antenna array and a second antenna array in an antenna assembly according to an embodiment of this application;

FIG. 38 is an axial ratio diagram 3 of a first antenna array and a second antenna array in an antenna assembly in a zenith direction according to an embodiment of this application;

FIG. 39 is a maximum axial ratio diagram 2 of a first antenna array and a second antenna array in an antenna assembly within ±30° according to an embodiment of this application;

FIG. 40 is a diagram 6 of a structure of an antenna assembly according to an embodiment of this application;

FIG. 41 is a diagram 4 of a structure of a first antenna stub in an antenna assembly according to an embodiment of this application;

FIG. 42 is a distribution diagram 3 of currents on a first antenna stub in an antenna assembly according to an embodiment of this application;

FIG. 43 is a diagram of a structure of a conductive plate in an antenna assembly according to an embodiment of this application;

FIG. 44 is a distribution diagram of currents on a conductive plate in an antenna assembly according to an embodiment of this application;

FIG. 45 is an active S11 curve diagram 4 of an antenna assembly according to an embodiment of this application;

FIG. 46 is a gain diagram of a first antenna array and a slot antenna in an antenna assembly according to an embodiment of this application;

FIG. 47 is an axial ratio diagram of a first antenna array in an antenna assembly in a zenith direction according to an embodiment of this application;

FIG. 48 is a maximum axial ratio diagram of a first antenna array in an antenna assembly within ±30° in a zenith direction according to an embodiment of this application;

FIG. 49 is a diagram 7 of a structure of an antenna assembly according to an embodiment of this application;

FIG. 50 is a diagram 1 of a structure of a vehicle according to an embodiment of this application; and

FIG. 51 is a diagram 2 of a structure of a vehicle according to an embodiment of this application.

Descriptions of reference numerals: 10: substrate; 20: first antenna array; 30: second antenna array; 40: conductive ring; 50: first feed device; 60: second feed device; 100: vehicle body; 101: conductive grounding layer; 110: spoiler; 120: shark fin antenna; 201: first antenna stub; 202: first capacitor; 203: second capacitor; 204: inductor; 205: first dielectric pillar; 206: first accommodation hole; 207: conductive sheet; 301: second antenna stub; 302: third capacitor; 303: second dielectric pillar; 304: second accommodation hole; 305: fourth capacitor; 306: filter capacitor; 307: dielectric plate; 308: conductive plate; 309: slot; 501: first primary phase shifter; 502: first secondary phase shifter; 503: second secondary phase shifter; 601: second primary phase shifter; 602: third secondary phase shifter; 603: fourth secondary phase shifter; 2011: first section; 2012: second section; 2013: third section; 2014: fourth section; 2015: fifth section; 3011: sixth section; 3012: seventh section; 3013: eighth section; 3014: ninth section; 3015: tenth section; 3016: feed stub; 3017: first transverse stub; and 3018: second transverse stub.

### DETAILED DESCRIPTION OF ILLUSTRATIVE EMBODIMENTS

The following describes the technical solutions in embodiments of this application with reference to the accompanying drawings in embodiments of this application. It is clear that the described embodiments are merely a part rather than all of embodiments of this application.

Terms “first” and “second” mentioned below are merely intended for a purpose of description, and shall not be understood as an indication or implication of relative importance or implicit indication of a quantity of indicated technical features. Therefore, a feature limited by “first”, “second”, or the like may explicitly or implicitly include one or more features.

In addition, in embodiments of this application, orientation terms such as “up”, “down”, “left”, “right”, “horizontal”, and “vertical” are defined relative to orientations in which components are schematically placed in the accompanying drawings. It should be understood that, these directional terms are relative concepts that are used for relative description and clarification, and may vary accordingly based on changes of the orientations in which the components are placed in the accompanying drawings.

In embodiments of this application, unless otherwise clearly specified and limited, a term “connection” should be understood in a broad sense. For example, the “connection” may be a fastened connection, an electrical connection, a detachable connection, or an integral connection, may be a direct connection, or an indirect connection implemented through an intermediate medium.

Coupling: The coupling may be understood as direct coupling and/or indirect coupling, and a “coupling connection” may be understood as a direct coupling connection and/or an indirect coupling connection. The direct coupling may also be referred to as an “electrical connection”, and may be understood as physical contact and electrical conduction of components, or may be understood as a form in which different components in a line structure are connected through a physical line that may transmit an electrical signal, for example, a copper foil or a conductive wire of a printed circuit board (printed circuit board, PCB). The “indirect coupling” may be understood as electrical conduction of two conductors through air or without contact. In an embodiment, the indirect coupling may also be referred to as capacitive coupling. For example, signal transmission is implemented by forming an equivalent capacitor through coupling in a gap between two spaced conductive members.

Capacitor: The capacitor may be understood as a lumped capacitor and/or a distributed capacitor. The lumped capacitor is a capacitive component, for example, a capacitive element. The distributed capacitor (or a distributed type capacitor) is an equivalent capacitor including two conductive members that are spaced apart by a specific gap.

Inductor: The inductor may be understood as a lumped inductor and/or a distributed inductor. The lumped inductor is an inductive component, for example, an inductor element. The distributed inductor (or distributed type inductor) is an equivalent inductor formed by a conductive member of a specific length (for example, a conductive sheet or a conducting wire), for example, an equivalent inductor formed by a conductor through curling or rotation.

Radiator or antenna stub: The radiator or antenna stub is an apparatus configured to receive/send electromagnetic wave radiation on an antenna. In some cases, an “antenna” is understood as a radiator in a narrow sense. The antenna converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator via a feeder. The radiator converts the energy into specific polarized electromagnetic wave energy and radiates the energy in a required direction. A receive radiator converts specific polarized electromagnetic wave energy from a specific direction of space into modulated high-frequency current energy, and transmits the modulated high-frequency current energy to an input end of a receiver through a feeder.

The radiator (or antenna stub) may include a conductor having a specific shape and size, for example, a linear radiator may or a sheet-like radiator. A specific shape is not limited in this application. In an embodiment, the linear radiator may be referred to as a wire antenna for short. In an embodiment, the linear radiator may be implemented by a conductive side frame, and may also be referred to as a side frame antenna. In an embodiment, the linear radiator may be implemented by a bracketed conductor, and may also be referred to as a bracketed antenna. In an embodiment, a wire diameter (for example, including a thickness and a width) of the linear radiator or a radiator of the wire antenna is far less than a wavelength (for example, a dielectric wavelength) (for example, is less than 1/16 of the wavelength), and a length may be compared with the wavelength (for example, the dielectric wavelength) (for example, the length is approximately ⅛ of the wavelength, or ⅛ to ¼ of the wavelength, or ¼ to ½ of the wavelength, or greater). Main forms of the wire antenna include a dipole antenna, a half-wave dipole antenna, a monopole antenna, a loop antenna, and an inverted F antenna (Inverted F Antenna, IFA). For example, for the dipole antenna, each dipole antenna usually includes two radiation stubs, and each stub is fed by a feed portion from a feed end of the radiation stub. For example, the inverted F antenna (IFA) may be considered as being obtained by adding a ground path to a monopole antenna. The IFA has a feed point and a ground point, and is referred to as the inverted F antenna because a side view of the IFA is in an inverted F shape. In an embodiment, a sheet-like radiator may include a microstrip antenna, or a patch antenna, for example, a planar inverted F antenna (PIFA). In an embodiment, the sheet-like radiator may be implemented by a planar conductor (for example, a conductive sheet or a conductive coating). In an embodiment, the sheet-like radiator may include a conductive sheet, for example, a copper sheet. In an embodiment, the sheet-like radiator may include a conductive coating, for example, silver paste. The sheet-like radiator is in a circle shape circle, a rectangle, a loop, or the like. A specific shape is not limited in this application. A structure of the microstrip antenna usually includes a dielectric substrate, a radiator, and a ground plane, where the dielectric substrate is disposed between the radiator and the ground plane.

The radiator (or antenna stub) may also include a slot or a slit formed on the conductor, for example, a closed or semi-closed slot or slit formed on a grounded conductor surface. In an embodiment, a radiator with a slot or a slit may be referred to as a slot antenna or a slotted antenna for short. In an embodiment, a radial size (for example, including a width) of the slot or slit of the slot antenna/slotted antenna is far less than a wavelength (for example, a dielectric wavelength) (for example, is less than 1/16 of the wavelength), and a length size may be compared with the wavelength (for example, the dielectric wavelength) (for example, the length is approximately ⅛ of the wavelength, or ⅛ to ¼ of the wavelength, or ¼ to ½ of the wavelength, or greater). In an embodiment, a radiator with a closed slot or slit may be referred to as a closed slot antenna for short. In an embodiment, a radiator with a semi-closed slot or slit (for example, an opening is additionally provided on the closed slot or slit) may be referred to as an open slot antenna for short. In some embodiments, the slot is long bar-shaped. In some embodiments, a length of the slot is approximately half the wavelength (for example, the dielectric wavelength). In some embodiments, a length of the slot is approximately an integer multiple of the wavelength (for example, a one-fold dielectric wavelength). In some embodiments, the slot may be used for feeding through a transmission line bridged on one side or two sides of the slot. In this way, a radio frequency electromagnetic field is excited on the slot, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced apart from the ground plane and is grounded at two ends of the radiator, to form a closed or semi-closed slot or slit. In an embodiment, the radiator of the slot antenna or the slotted antenna may be implemented by a bracketed conductor that is grounded at two ends, and may also be referred to as a bracketed antenna.

Ground/ground plane: The ground/ground plane may generally represent at least a part of any grounding layer, or grounding plate, or grounding metal layer of an electronic device (for example, a mobile phone), or at least a part of any combination of any grounding layer, grounding plate, grounding part, or the like. The “ground/ground plane” may be configured to ground a component of the electronic device. In an embodiment, the “ground/ground plane” may include any one or more of the following: a grounding layer of a circuit board of the electronic device, a grounding plate formed in a middle frame of the electronic device, a grounding metal layer formed by a metal film under a screen, a conductive grounding layer of a battery, and a conductive member or a metal member electrically connected to the grounding layer/grounding plate/metal layer. In an embodiment, the circuit board may be a printed circuit board (printed circuit board, PCB), for example, an 8-layer, 10-layer, or 12-layer to 14-layer board with 8, 10, 12, 13, or 14 layers of conductive materials, or an element that is separated and electrically insulated by a dielectric layer or an insulation layer, for example, a glass fiber or a polymer. In an embodiment, the circuit board includes a dielectric substrate, a grounding layer, and a trace layer. The trace layer and the grounding layer are electrically connected to each other through a via. In an embodiment, components such as a display, a touchscreen, an input button, a transmitter, a processor, a memory, a battery, a charging circuit, and a system-on-chip (system-on-chip, SoC) structure may be mounted on or connected to the circuit board, or electrically connected to the trace layer and/or the grounding layer in the circuit board. For example, a radio frequency source is disposed on the trace layer.

Any of the foregoing grounding layer, or grounding plate, or grounding metal layer is made of a conductive material. In an embodiment, the conductive material may be any one of the following materials: copper, aluminum, stainless steel, brass and an alloy thereof, copper foil on an insulation substrate, aluminum foil on the insulation substrate, gold foil on the insulation substrate, silver-plated copper, silver-plated copper foil on the insulation substrate, silver foil on the insulation substrate, tin-plated copper, cloth impregnated with graphite powder, a graphite-coated substrate, a copper-plated substrate, a brass-plated substrate, and an aluminum-plated substrate. A person skilled in the art may understand that the grounding layer/grounding plate/grounding metal layer may alternatively be made of another conductive material.

Grounding: The grounding is coupling with the ground/ground plane in any manner. In an embodiment, grounding may be grounding via an entity, for example, grounding via an entity (or referred to as entity grounding) at a specific position on a side frame is implemented through some mechanical members of a middle frame. In an embodiment, the grounding may be grounding through a component, for example, grounding through a component (or referred to as component grounding) like a capacitor/inductor/resistor connected in series or in parallel.

Resonance frequency band: A range of a resonance frequency is a resonance frequency band, and a return loss of any frequency on the resonance frequency band may be less than −6 dB or −5 dB.

Communication frequency band/operating frequency band: Regardless of a type of antenna, the antenna constantly operates in a specific frequency range (a frequency bandwidth). For example, an operating frequency band of an antenna supporting a B40 frequency band includes a frequency in a range of 2300 MHz to 2400 MHz. In other words, the operating frequency band of the antenna includes the B40 frequency band. A frequency range that meets a requirement of an indicator may be considered as an operating frequency band of an antenna. A width of the operating frequency band is referred to as an operating bandwidth. An operating bandwidth of an omnidirectional antenna may reach 3% to 5% of a center frequency. An operating bandwidth of a directional antenna may reach 5% to 10% of the center frequency. The bandwidth may be considered as a range of frequencies on both sides of the center frequency (for example, a resonance frequency of a dipole), where an antenna characteristic is within an acceptable range of values for the center frequency.

The resonance frequency band and the operating frequency band may be the same, or may partially overlap. In an embodiment, one or more resonance frequency bands of an antenna may cover one or more operating frequency bands of the antenna.

End/point: An “end/point” in a first end/second end/feed end/ground end/feed point/ground point/connection point of an antenna radiator cannot be understood in a narrow sense as an endpoint or an end part that is physically disconnected from another radiator, and may also be considered as a point or a section on a continuous radiator. In an embodiment, the “end/point” may include a connection/coupling area that is on the antenna radiator and that is coupled to another conductive structure. For example, the feed end/feed point may be a coupling area (for example, an area opposite to a part of the feed circuit) that is on the antenna radiator and that is coupled to the feed structure or the feed circuit. For another example, the ground end/ground point may be a connection/coupling area that is on the antenna radiator and that is coupled to a grounding structure or a grounding circuit.

Open end and closed end: In some embodiments, the open end and closed end are defined based on whether the open end and the closed end are grounded, for example, the closed end is grounded, and the open end is not grounded. In some embodiments, the open end and the closed end are, for example, relative to another conductor. The closed end is electrically connected to the another conductor, and the open end is not electrically connected to the another conductor. In an embodiment, the open end may also be referred to as a floating end, a free end, an opening end or an open-circuit end. In an embodiment, the closed end may also be referred to as a ground end or a short-circuit end. It should be understood that, in some embodiments, another conductor may be coupled and connected through the open end, to transfer coupling energy (which may be understood as transferring a current).

In some embodiments, the “closed end” may also be understood from a perspective of current distribution. The closed end, the ground end, or the like may be understood as a current strong point on a radiator, or may be understood as an electric field weak point on a radiator. In an embodiment, the closed end is coupled to an electronic component (for example, a capacitor or an inductor), so that a current distribution characteristic of the current strong point/an electric field weak point on the radiator may not be changed. In an embodiment, a slit (for example, a slot filled with an insulation material) at or near the closed end may not change a current distribution characteristic of the current strong point/electric field weak point of the radiator at the slit.

In some embodiments, the “open end” may also be understood from a perspective of current distribution. The open end, the floating end, or the like may be understood as a current weak point on a radiator, or may be understood as an electric field strong point on a radiator. In an embodiment, the open end is coupled to an electronic component (for example, a capacitor or an inductor), so that a current distribution characteristic of the current weak point/electric field strong point on the radiator may not be changed.

It should be understood that a radiator end (similar to a radiator at an opening of the open end or the floating end from a perspective of a radiator structure) in a slot is coupled to the electronic component (for example, the capacitor or the inductor), so that the radiator end is a current strong point/an electric field weak point. In this case, it should be understood that the radiator end in the slot is actually a closed end, a ground end, or the like.

Limitations such as collinearity, coaxiality, coplanarity, symmetry (for example, axisymmetricity or centrosymmetry), parallelism, perpendicularity, and sameness (for example, a same length and a same width) mentioned in embodiments of this application are all for a current technology level, but are not absolutely strict definitions in a mathematical sense. A deviation less than a predetermined threshold (for example, 1 mm, 0.5 m, or 0.1 mm) may exist in a width direction between edges of two collinear radiation stubs or two collinear antenna elements. A deviation less than a predetermined threshold may exist between edges of the two coplanar radiation stubs or two coplanar antenna elements in a direction perpendicular to a plane on which the two coplanar radiation stubs or two coplanar antenna elements are located. A deviation of a predetermined angle may exist between two antenna elements that are parallel or perpendicular to each other. In an embodiment, the predetermined threshold may be less than or equal to a threshold of 1 mm. For example, the predetermined threshold may be 0.5 mm, or may be 0.1 mm. In an embodiment, the predetermined angle may be an angle within a range of ±10°, for example, a deviation of the predetermined angle is ±5°.

Codirectional/Contra-directional current distribution mentioned in embodiments of this application should be understood as that main currents on conductors on a same side are codirectional/contra-directional. For example, when currents distributed codirectionally are excited on a bent conductor or an annular conductor (for example, a current path is also bent or annular), it should be understood that although main currents excited on conductors on two sides of the annular conductor (for example, on conductors around a slot, or on conductors on two sides of a slot) are contra-directional, the main currents still meet definition of the currents distributed codirectionally in this application. In an embodiment, that currents on a conductor are codirectional may mean that the currents on the conductor have no reversal point. In an embodiment, that currents on a conductor are contra-directional may mean that the currents on the conductor have at least one reversal point. In an embodiment, that currents on two conductors are codirectional may mean that none of the currents on the two conductors has a reversal point and the currents flow codirectionally. In an embodiment, that currents on two conductors are contra-directional may mean that none of the currents on the two conductors has a reversal point and the currents flow contra-directionally. It may be correspondingly understood that directions of currents on a plurality of conductors are codirectional/contra-directional.

An embodiment of this application provides an antenna assembly. The antenna assembly may be disposed on a device like a vehicle, a communication base station, or a mobile terminal, to receive and transmit signals through the antenna assembly. For example, in an implementation in which the antenna assembly is disposed on a vehicle, the antenna assembly may be disposed on a telematics box (T-BOX). The telematics box is connected to an in-vehicle host of the vehicle, so that the in-vehicle host can communicate with a device like a user terminal, a satellite, or a communication base station through the telematics box. For example, the antenna assembly may include a global navigation satellite system (GNSS) antenna, to implement BeiDou navigation satellite system (BDS) navigation or global positioning system (GPS) navigation. Correspondingly, the in-vehicle host may implement a positioning function and a navigation function of the vehicle through the telematics box.

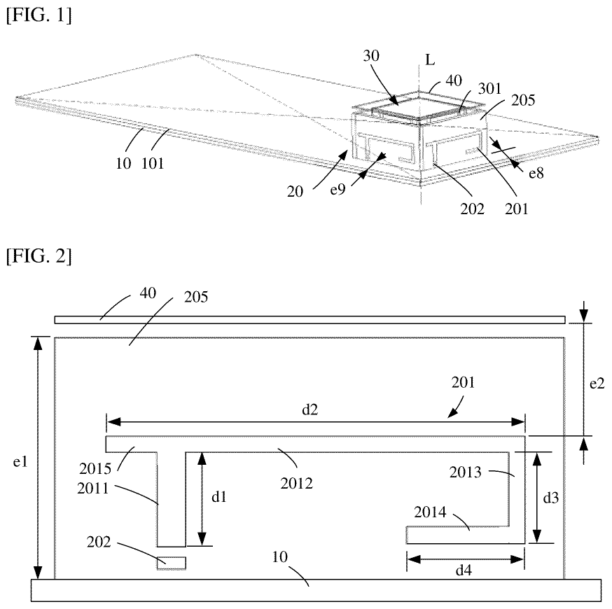

Refer to FIG. 1. The antenna assembly provided in this embodiment of this application may include a substrate 10. The substrate 10 may be an insulation plate or a plate body having a specific dielectric constant. In an embodiment, the substrate 10 may be a circuit board, for example, a PCB. A conductive grounding layer 101 is disposed in the substrate 10. It may be understood that the conductive grounding layer 101 may include a metal layer, for example, copper or aluminum. Certainly, a material of the conductive grounding layer 101 may alternatively include another non-metal conductive material. This is not limited in embodiments of this application. Certainly, the substrate 10 may alternatively include an epoxy glass cloth laminate (FR-4), an epoxy resin board, or the like. The conductive grounding layer 101 is grounded, and the conductive grounding layer 101 may be used as a ground plane of the antenna assembly.

For example, in an implementation in which the conductive grounding layer 101 includes a metal layer, the metal layer may be formed on a surface of the substrate 10 or in a substrate body of the substrate 10 through electroplating, deposition, or the like. It should be understood that FIG. 1 shows only the conductive grounding layer 101 in a simplified manner, and does not limit disposing of the conductive grounding layer 101 on an upper surface of the substrate. In an embodiment, the metal layer may alternatively be directly attached to the substrate 10. In an implementation in which the conductive grounding layer 101 includes a non-metal conductive material, the conductive grounding layer 101 may be formed on a surface of the substrate 10 through coating, or the like.

Still refer to FIG. 1. The antenna assembly in this embodiment of this application further includes a first antenna array 20. The first antenna array 20 is disposed on the conductive grounding layer 101. Correspondingly, the substrate 10 serves as a basis of the first antenna array 20, and the substrate 10 may support and fasten the first antenna array 20. The first antenna array 20 includes a plurality of first antenna stubs 201, and there is a first preset included angle between the substrate and a plane on which each first antenna stub 201 is located. For example, the first preset included angle may be 30° to 150° (for example, 30°, 90°, or 150°). In this embodiment of this application, an example in which the first preset included angle is about 90° is used for description. In other words, the plane on which the first antenna stub 201 is located is approximately perpendicular to the substrate 10. It may be understood that this is not limited in embodiments of this application. In an embodiment, being approximately perpendicular may be understood as that the first preset included angle is within a range of 85° to 95°.

In some embodiments, the first antenna stubs 201 may have same structures and shapes, and the plurality of first antenna stubs 201 are disposed around a preset straight line L perpendicular to the substrate 10 at equal central angles. In other words, in the plurality of first antenna stubs 201, included angles (central angles) between lines connecting same positions on any two adjacent first antenna stubs 201 and the preset straight line L are equal. For example, included angles (central angles) between lines connecting first open ends of every two adjacent first antenna stubs 201 and the preset straight line L are equal. For example, there may be three to six first antenna stubs 201, for example, three, four, or six first antenna stubs 201. In an implementation in which there are three first antenna stubs 201, a central angle between every two adjacent first antenna stubs 201 may be 120°.

In some embodiments, the first antenna stubs 201 may have same structures and shapes, the plurality of first antenna stubs 201 are disposed in a centrosymmetric manner relative to the preset straight line L, and the first antenna stubs 201 are disposed in a rotationally symmetric manner relative to the preset straight line L at an angle of 120°. In an implementation in which there are four first antenna stubs 201 (as shown in FIG. 1), the first antenna stubs 201 are disposed in a centrosymmetric manner relative to the preset straight line L, and the first antenna stubs 201 are disposed in a rotationally symmetric manner relative to the preset straight line L at an angle of 90°. In an implementation in which there are six first antenna stubs 201, the first antenna stubs 201 are disposed in a centrosymmetric manner relative to the preset straight line L, and the first antenna stubs 201 are disposed in a rotationally symmetric manner relative to the preset straight line L at an angle of 60°.

In the foregoing implementation, signals received by first feed ends of adjacent first antenna stubs 201 have an equal phase difference, for the first antenna array 20 to generate a circular polarization signal. In other words, the first antenna stubs 201 cooperate with each other to form a circular polarization signal. In this way, the first antenna array 20 can receive a signal in any polarization direction. This improves universality of the antenna assembly. It may be understood that a phase difference between feeding signals of adjacent first antenna stubs 201 may be properly set based on a quantity of first antenna stubs 201, so that in a direction surrounding the preset straight line L, feeding signals of the first antenna stubs 201 have an equal amplitude and phase feeding signals have a same phase difference in sequence, to generate a circular polarization signal. For example, in an implementation in which there are three first antenna stubs 201, in the direction surrounding the preset straight line L, feeding signals of the first antenna stubs 201 have an equal amplitude, and a 120° phase difference in sequence. In an implementation in which there are four first antenna stubs 201, in the direction surrounding the preset straight line L, feeding signals of the first antenna stubs 201 have an equal amplitude, and a 90° phase difference in sequence. In an implementation in which there are six first antenna stubs 201, in the direction surrounding the preset straight line L, feeding signals of the first antenna stubs 201 have an equal amplitude, and a 60° phase difference in sequence. It should be understood that the same phase difference in this application refers to a phase difference that is the same or approximately the same (for example, a difference between two phase differences is within 5%). Correspondingly, “90° phase difference in sequence” should be understood as a phase difference of 90°×(1±5%) in sequence. “120° phase difference in sequence”, “60° phase difference in sequence”, and the like should be understood similarly.

In the foregoing implementation, the conductive grounding layer 101 may reflect a signal sent by the first antenna stub 201 in a direction away from the substrate 10, so that the signal can be concentrated in the direction away from the substrate 10, to improve signal strength in the direction away from the substrate 10.

In some embodiments, the first antenna stub 201 extends on a side of the substrate 10, and the first antenna stub 201 has two opposite ends in an extension direction, where one end may be used as a first feed end of the first antenna stub 201, the first feed end is configured to receive external feeding, and other end may be used as a first open end of the first antenna stub 201. The first open end and the conductive grounding layer 101 are spaced from each other. In other words, the first open end is not directly electrically connected to the conductive grounding layer 101. For example, the first open end may not be coupled to the conductive grounding layer 101, or the first open end is coupled to the conductive grounding layer 101 through a capacitor.

Refer to FIG. 1 and FIG. 2. In the foregoing implementation, the antenna assembly further includes a first capacitor 202. There are a plurality of first capacitors 202, and each first capacitor 202 is coupled to a first feed end of one first antenna stub 201. In other words, a corresponding first antenna stub 201 is fed through the first capacitor 202. The first capacitor 202 may adjust current distribution on the first antenna stub 201, so that a current, between the first feed end and the first open end, on the first antenna stub 201 is a codirectional current (codirectional current distribution), and an amplitude of the current on the first antenna stub 201 gradually increases from the first feed end to a middle part or an approximately middle part of the first antenna stub 201 in an extension direction. In addition, the amplitude of the current on the first antenna stub 201 may gradually increase from the first open end to the middle part or the approximately middle part of the first antenna stub 201 in the extension direction, so that the first antenna stub 201 operates in a differential mode (differential mode, DM for short). In an embodiment, through disposing of the first capacitor 202, current on the first antenna stub 201 may be understood as current distribution with small values at two ends and a large value in the middle. In an embodiment, the middle part of the first antenna stub 201 is mainly used for signal transmission and reception. A large amplitude of a current on the middle part of the first antenna stub 201 can increase gains of the first antenna stub 201 and the antenna assembly, so that performance of the antenna assembly is improved.

It may be understood that when current distribution on an antenna stub is codirectional current distribution, and there is a current strong point in the middle part, it may be considered that the antenna stub operates in a differential mode (DM mode). In a specific embodiment, a current on the antenna stub operating in the DM mode is a codirectional current, and an amplitude of the current gradually increases from a feed end (for example, the first feed end) to the middle part of the antenna stub, and gradually decreases from the middle part of the antenna stub to an open end (for example, the first open end) of the antenna stub. Alternatively, in a specific embodiment, a current on the antenna stub operating in the DM mode is a codirectional current, and an amplitude of the current gradually increases from the first feed end to the middle part of the antenna stub, and gradually increases from the first open end to the middle part of the antenna stub.

In this embodiment of this application, a capacitance value of the first capacitor 202 may range from 0.1 pF to 0.5 pF. For example, the capacitance value of the first capacitor 202 may be 0.1 pF, 0.25 pF, 0.5 pF, or the like. A resonance frequency of the first antenna stub 201 gradually decreases as the capacitance value of the first capacitor 202 increases. The capacitance value of the first capacitor 202 ranges from 0.1 pF to 0.5 pF, so that an excessively low resonance frequency of the first antenna stub 201 due to an excessively large capacitance value of the first capacitor 202 can be avoided while it is ensured that the first antenna stub 201 operates in the DM mode.

It may be understood that the first capacitor 202 may include a lumped capacitor and/or a distributed capacitor. The lumped capacitor is a capacitive component, for example, a capacitive element. The distributed capacitor (or a distributed-type capacitor) is an equivalent capacitor including two conductive members that are spaced apart by a specific gap. Correspondingly, a conductive member may be disposed outside the first feed end at a specific spacing. A distance between the first feed end and the conductive member is properly set, so that the first feed end and the conductive member may form an equivalent capacitor (the first capacitor 202).

Still refer to FIG. 1 and FIG. 2. In the antenna assembly provided in this embodiment of this application, the conductive grounding layer 101 is disposed on the substrate 10, the first antenna array 20 is disposed on the conductive grounding layer 101, the first antenna array 20 includes the plurality of first antenna stubs 201, and there is a first preset included angle between the substrate 10 and a plane on which each first antenna stub 201 is located. There are a plurality of first capacitors 202, each first capacitor 202 is electrically connected to a first feed end of one first antenna stub 201, and a first open end of the first antenna stub 201 and the conductive grounding layer 101 are spaced from each other. Each first antenna stub 201 is fed through a corresponding first capacitor 202. The first capacitor 202 may adjust current distribution on the first antenna stub 201, so that a current on the first antenna stub 201 is a codirectional current. In addition, an amplitude of the current on the first antenna stub 201 gradually increases from the first feed end to a middle part of the first antenna stub 201 in an extension direction, and the amplitude of the current on the first antenna stub 201 may gradually increase from the first open end to the middle part of the first antenna stub 201 in the extension direction. There is a current strong point on the middle part of the first antenna stub 201, so that the first antenna stub 201 operates in a differential mode. The middle part of the first antenna stub 201 is mainly used for signal transmission and reception. A strong current on the middle part of the first antenna stub 201 can increase gains of the first antenna stub 201 and the antenna assembly, so that performance of the antenna assembly is improved.

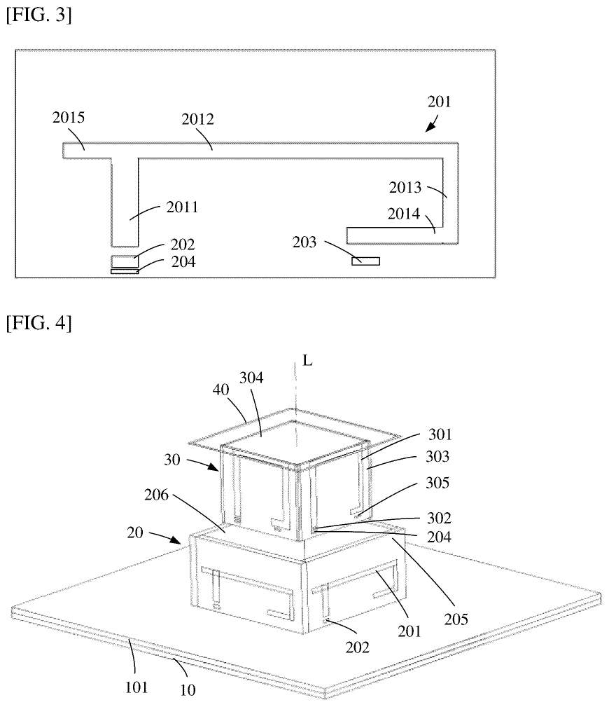

Refer to FIG. 3. In an embodiment of this application, the antenna assembly may further include a second capacitor 203. There are a plurality of second capacitors 203, and a first open end of one first antenna stub 201 is electrically coupled to the conductive grounding layer 101 through one second capacitor 203. In this way, a resonance frequency of the first antenna stub 201 connected to the second capacitor 203 is reduced through the second capacitor 203, so that a size (a length in an extension direction) of the first antenna stub 201 can be reduced, to implement miniaturization of the antenna assembly.

In the foregoing implementation, a capacitance value of the second capacitor 203 may range from 0.1 pF to 0.5 pF. For example, the capacitance value of the second capacitor 203 may be 0.1 pF, 0.25 pF, 0.5 pF, or the like. It may be understood that if the capacitance value of the second capacitor 203 is excessively large, impedance matching of the first antenna stub 201 is difficult. The capacitance value of the second capacitor 203 ranges from 0.1 pF to 0.5 pF, so that impedance matching difficulty of the first antenna stub 201 is reduced while it is ensured that the first antenna stub 201 operates in the DM mode and the size of the first antenna stub 201 is reduced through the second capacitor 203. It may be understood that a structure of the second capacitor 203 may be approximately the same as a structure of the first capacitor 202. Details are not described herein again.

Still refer to FIG. 3. In some embodiments, the antenna assembly further includes an inductor 204. There are a plurality of inductors 204. One end of each first capacitor 202 is electrically connected to a first feed end of one first antenna stub 201, and the other end of each first capacitor 202 is electrically connected to an end of one inductor 204. In other words, the first capacitor 202 and the inductor 204 that correspond to each first feed end are connected in series, and an external signal is fed into a corresponding first feed end after sequentially passing through the inductor 204 and the first capacitor 202. In this way, the inductor 204 can reduce a resonance frequency of the first antenna stub 201 corresponding to the inductor 204, so that a size of the first antenna stub 201 can be reduced, to implement miniaturization of the antenna assembly.

Still refer to FIG. 1 and FIG. 4. In this embodiment of this application, the antenna assembly further includes a second feed source and a second antenna array 30. The second antenna array 30 includes a plurality of second antenna stubs 301, and there is a second preset included angle between the substrate and a plane on which each second antenna stub 301 is located. Each of the plurality of second antenna stubs 301 includes a second feed end, the plurality of second feed ends are all coupled to the second feed source, and the second antenna stub 301 is configured to receive a signal of the second feed source for radiation on a second operating frequency band. For example, the second preset included angle may be 30° to 150° (for example, 30°, 90°, or 150°). In this embodiment of this application, an example in which the second preset included angle is about 90° is used for description. In other words, a plane on which the second antenna stub 301 is located is approximately perpendicular to the substrate 10. It may be understood that this is not limited in embodiments of this application. In an embodiment, being approximately perpendicular may be understood as that the second preset included angle is within a range of 85° to 95°.

In some embodiments, the second antenna stubs 301 may have same structures and shapes, and the plurality of second antenna stubs 301 may be disposed around a preset straight line L at equal central angles. In other words, in the plurality of second antenna stubs 301, included angles (central angles) between lines connecting same positions on any two adjacent second antenna stubs 301 and the preset straight line L are equal. For example, there may be three to six second antenna stubs 301, for example, three, four, or six second antenna stubs 301. In an implementation in which there are three second antenna stubs 301, the second antenna stubs 301 are disposed in a centrosymmetric manner relative to the preset straight line L, and the second antenna stubs 301 are disposed in a rotationally symmetric manner relative to the preset straight line L at an angle of 120°. In an implementation in which there are four second antenna stubs 301 (as shown in FIG. 4), the second antenna stubs 301 are disposed in a centrosymmetric manner relative to the preset straight line L, and the second antenna stubs 301 are disposed in a rotationally symmetric manner relative to the preset straight line L at an angle of 90°. In an implementation in which there are six second antenna stubs 301, the second antenna stubs 301 are disposed in a centrosymmetric manner relative to the preset straight line L, and the second antenna stubs 301 are disposed in a rotationally symmetric manner relative to the preset straight line L at an angle of 60°.

In this embodiment of this application, the second antenna stub 301 extends on a side of the substrate 10, and the second antenna stub 301 has two opposite ends in an extension direction, where one end may be used as a second feed end of the second antenna stub 301, the second feed end is configured to receive external feeding, and the other end may be used as a second open end of the second antenna stub 301. The second open end and the conductive grounding layer 101 are spaced from each other. In other words, the second open end is not directly electrically connected to the conductive grounding layer 101. For example, the second open end may not be coupled to the conductive grounding layer 101, or the second open end is coupled to the conductive grounding layer 101 through a capacitor.

In the foregoing implementation, phase differences of signals in adjacent second antenna stubs 301 are equal, so that the second antenna array 30 generates a circular polarization signal. In this way, the second antenna array 30 can receive a signal in any polarization direction. This improves universality of the antenna assembly. It may be understood that a phase difference between feeding signals of adjacent second antenna stubs 301 may be properly set based on a quantity of second antenna stubs 301, so that in a direction surrounding the preset straight line L, feeding signals of the second antenna stubs 301 have an equal amplitude, and the feeding signals have a same phase difference in sequence, to generate a circular polarization signal. For example, in an implementation in which there are three second antenna stubs 301, in the direction surrounding the preset straight line L, feeding signals of the second antenna stubs 301 have an equal amplitude, and a phase difference of 120° in sequence. In an implementation in which there are four second antenna stubs 301, in the direction surrounding the preset straight line L, feeding signals of the second antenna stubs 301 have an equal amplitude, and a phase difference of 90° in sequence. In an implementation in which there are six second antenna stubs 301, in the direction surrounding the preset straight line L, feeding signals of the second antenna stubs 301 have an equal amplitude, and a phase difference of 60° in sequence.

In this embodiment of this application, a quantity of first antenna stubs 201 may be the same as a quantity of second antenna stubs 301. As shown in FIG. 4, the quantity of first antenna stubs 201 and the quantity of second antenna stubs 301 may each be four. Each first antenna stub 201 corresponds to one second antenna stub 301. A phase difference between two adjacent first antenna stubs 201 is 90°, and a phase difference between two adjacent second antenna stubs 301 is also 90°. Certainly, the quantity of first antenna stubs 201 may alternatively be different from the quantity of second antenna stubs 301. This is not limited in embodiments of this application.

In the foregoing implementation, a frequency of an operating frequency band (a first operating frequency band) of the first antenna stubs 201 is different from a frequency of an operating frequency band (a second operating frequency band) of the second antenna stubs 301, so that resonance frequencies excited by the first antenna array 20 and the second antenna array 30 are different. In other words, frequency bands covered by the first antenna array 20 and the second antenna array 30 are different, to increase a coverage frequency of the antenna assembly and increase a bandwidth of the antenna assembly.

In this embodiment of this application, the first antenna array 20 and the second antenna array 30 may have a plurality of structures. The following provides descriptions in a plurality of scenarios.

### Scenario 1

Still refer to FIG. 1 and FIG. 4. The first antenna array 20 includes a first dielectric pillar 205. The first dielectric pillar 205 is disposed on the substrate 10, and the plurality of first antenna stubs 201 are disposed on a side wall of the first dielectric pillar 205. In this way, the first antenna stub 201 may be fastened and supported through the first dielectric pillar 205, to improve structural stability of the antenna assembly. It may be understood that the first dielectric pillar 205 has a specific dielectric constant. The dielectric constant of the first dielectric pillar 205 may be properly selected based on performance of the first antenna array 20.

For example, a material of the first dielectric pillar 205 may include an epoxy glass cloth laminate (FR-4), epoxy resin, or the like. In an implementation in which the material of the first dielectric pillar 205 is the epoxy glass cloth laminate, the first dielectric pillar 205 has a small dielectric constant, to improve impedance matching performance of the first antenna array 20, and further increase a gain of the first antenna array 20.

In some embodiments, a geometric center line of the first dielectric pillar 205 is collinear with the preset straight line L. For example, the first dielectric pillar 205 may be cylindrical, and correspondingly, the first antenna stubs 201 may be distributed on a side wall of the first dielectric pillar 205 around the preset straight line L at equal central angles, so that central angles between any two adjacent first antenna stubs 201 are equal. Certainly, the first dielectric pillar 205 may alternatively be prismatic, and correspondingly, the first antenna stubs 201 may be disposed on a side surface that is of the first dielectric pillar 205 and that is parallel to the preset straight line L. For example, in an implementation in which there are four first antenna stubs 201, the first dielectric pillar 205 may be cuboid, and each first antenna stubs 201 is disposed on a surface that is of the first dielectric pillar 205 and that is parallel to the preset straight line L.

In the foregoing implementation, the first antenna stub 201 may be formed on the side wall of the first dielectric pillar 205 through electroplating, deposition, or the like. Certainly, the first antenna stub may alternatively be attached to the side wall of the first dielectric pillar 205.

Still refer to FIG. 2. The first antenna stub 201 may extend in a curved or bent shape on the first dielectric pillar 205. In this way, space occupied by the first antenna stub 201 can be reduced while it is ensured that the first antenna stub 201 has a specific length in an extension direction, so that a volume of the first dielectric pillar 205 can be reduced, to facilitate miniaturization of the antenna assembly.

For example, the first antenna stub 201 may include a first section 2011 extending in a direction parallel to the preset straight line L, a second section 2012 extending in a direction perpendicular to the preset straight line L, and a third section 2013 extending in the direction parallel to the preset straight line L. The first section 2011, the second section 2012, and the third section 2013 are sequentially connected to each other, and the first section 2011 and the third section 2013 are located between the second section 2012 and the substrate 10. In an embodiment, the first antenna stub 201 may further include a fourth section 2014 extending in the direction perpendicular to the preset straight line L. The fourth section 2014 may be connected to and extend from an end of the third section 2013, and is located between the first section 2011 and the third section 2013. An end that is of the first section 2011 and that is close to the substrate 10 may be the first feed end, an end that is of the first section 2011 and that is away from the substrate 10 is connected to an end of the second section 2012, and an end that is of the second section 2012 and that is away from the first section 2011 is connected to an end that is of the third section 2013 and that is away from the substrate 10. In an embodiment, the third section 2013 may be used as the first open end of the first antenna stub 201. In an embodiment, an end that is of the third section 2013 and that is close to the substrate 10 is connected to an end that is of the fourth section 2014 and that is away from the first section 2011. Correspondingly, an end that is of the fourth section 2014 and that is away from the third section 2013 may be used as the first open end of the first antenna stub 201. In an embodiment, the first open end of the first antenna stub 201 and the conductive grounding layer 101 on the substrate 10 are spaced from each other, and are coupled to each other through a component. In an embodiment, the first open end of the first antenna stub 201 and the conductive grounding layer 101 on the substrate 10 are spaced from each other, and are not coupled to each other through a component. In this way, the first antenna stub 201 including a plurality of sections may have a shape that is bent once or more, to further reduce space occupied by the first antenna stub 201.

Still refer to FIG. 2. In some implementations, the first antenna stub 201 further includes a fifth section 2015. The fifth section 2015 and the second section 2012 are collinearly disposed, the fifth section 2015 is located on a side that is of the first section 2011 and that is away from the second section 2012, and an end that is of the fifth section 2015 and that is close to the second section 2012 is connected to the second section 2012. The first antenna stub 201 may be tested through the fifth section 2015, to test the first antenna stub 201.

In the foregoing implementation, a total length of the first antenna stub 201 may range from 40 mm to 65 mm (for example, 40 mm, 43.75 mm, or 65 mm). The total length of the first antenna stub 201 may be a shortest distance between an end of the first antenna stub 201 at the first feed end and an end of the first antenna stub 201 at the first open end, namely, a length of a codirectional current when the first antenna stub 201 radiates a signal outward.

In the foregoing implementation, a length d1 of the first section 2011 may range from 7 mm to 10 mm (for example, 7 mm, 8.25 mm, or 10 mm), a sum d2 of a length of the second section 2012 and a length of the fifth section 2015 may range from 35 mm to 40 mm (for example, 35 mm, 37 mm, or 40 mm), a length d3 of the third section 2013 may range from 8 mm to 11 mm (for example, 8 mm, 9.5 mm, or 11 mm), and a length d4 of the fourth section 2014 may range from 8 mm to 10 mm (for example, 8 mm, 9 mm, or 10 mm). A length of the fifth section 2015 may be less than or equal to 20 mm, to avoid a case in which the fifth section 2015 is excessively long and affects resonance of the first antenna stub 201.

In the foregoing implementation, the end that is of the first section 2011 and that is close to the substrate 10 is the first feed end of the first antenna stub 201. Correspondingly, one electrode plate of the first capacitor 202 is electrically connected to the first feed end, and another electrode plate of the first capacitor 202 may be connected to a first feed device, so that the first feed device may perform feeding on the first antenna stub 201 through the first capacitor 202. For example, the first feed device may include a power splitter, a phase shifter, or the like. Certainly, the first feed device may include a microstrip line, a coplanar waveguide line, or the like. Through the first feed device, in the direction surrounding the preset straight line L, feeding signals of the first antenna stubs 201 may have an equal amplitude, and the feeding signals have a same phase difference in sequence, to generate a circular polarization signal.

It may be understood that the first capacitor 202 may alternatively be disposed on the first dielectric pillar 205, and the first capacitor 202 may be disposed between the first feed end and the substrate 10, to improve structural compactness of the antenna assembly. Certainly, the first capacitor 202 may alternatively be disposed on the substrate 10. Correspondingly, the first capacitor 202 may be connected to a corresponding first feed end through a conducting wire. The first feed device may be disposed on the substrate 10, and may transmit a feeding signal to the first feed device through a coaxial cable. The first feed device simultaneously performs feeding on the first antenna stubs 201, so that feeding signals of the first antenna stubs 201 have an equal amplitude, and the feeding signals have a same phase difference in sequence.

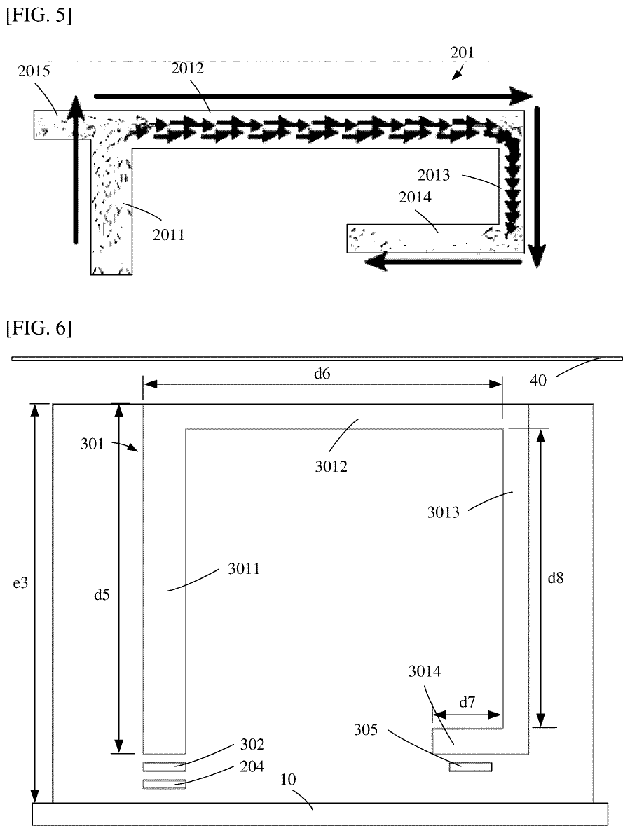

FIG. 5 shows a distribution diagram of currents on the first antenna stub 201. In the figure, a distribution density of arrows representing currents is positively correlated with current amplitudes. It can be learned from FIG. 5 that the first capacitor 202 may adjust current distribution on the first antenna stub 201, so that currents on the first section 2011, the second section 2012, the third section 2013, and the fourth section 2014 are codirectional currents, amplitudes of the currents on the first section 2011 and the fourth section 2014 are small, and an amplitude of the current on the second section 2012 is large. In this way, an amplitude of the current on the first antenna stub 201 gradually increases from the first feed end to a middle part or an approximately middle part of the first antenna stub 201 in an extension direction, and the amplitude of the current on the first antenna stub 201 gradually increases from the first open end to the middle part or approximately middle part of the first antenna stub 201 in the extension direction, so that the first antenna stub 201 operates in a DM mode.

Still refer to FIG. 3. In an implementation in which the antenna assembly includes the second capacitor 203, one electrode plate of the second capacitor 203 is connected to the first open end, and another electrode plate of the second capacitor 203 is electrically connected to the conductive grounding layer 101. The second capacitor 203 may be disposed on the first dielectric pillar 205, and the second capacitor 203 may be disposed between the fourth section 2014 and the substrate 10, to further improve structural compactness of the antenna assembly.

Still refer to FIG. 3. In an implementation in which the antenna assembly includes the inductor 204, the inductor 204 may be disposed between the first capacitor 202 and the first feed device. To be specific, the first feed device is connected to the first capacitor 202 through the inductor 204. An inductance value of the inductor 204 may be 10 nH to 15 nH (10 nH, 12.5 nH, 15 nH, or the like), to avoid an excessively large or small inductance value of the inductor 204 while it is ensured that a resonance frequency of the first antenna stub 201 is reduced, to reduce a size of the first antenna stub 201.

Refer to FIG. 4 and FIG. 6. In an implementation in which the antenna assembly includes the second antenna array 30, a first accommodation hole 206 is provided on the first dielectric pillar 205, a center line of the first accommodation hole 206 and a preset straight line L are collinearly disposed, and the second antenna array 30 may be disposed in the first accommodation hole 206. In this way, the second antenna array 30 can be prevented from occupying space, to reduce a volume of the antenna assembly. This facilitates miniaturization of the antenna assembly.

It may be understood that the first accommodation hole 206 may extend from an end that is of the first dielectric pillar 205 and that is away from the substrate 10 to the substrate 10, and the first accommodation hole 206 may penetrate the first dielectric pillar 205. Certainly, the first accommodation hole 206 may alternatively penetrate a part of the first dielectric pillar 205.

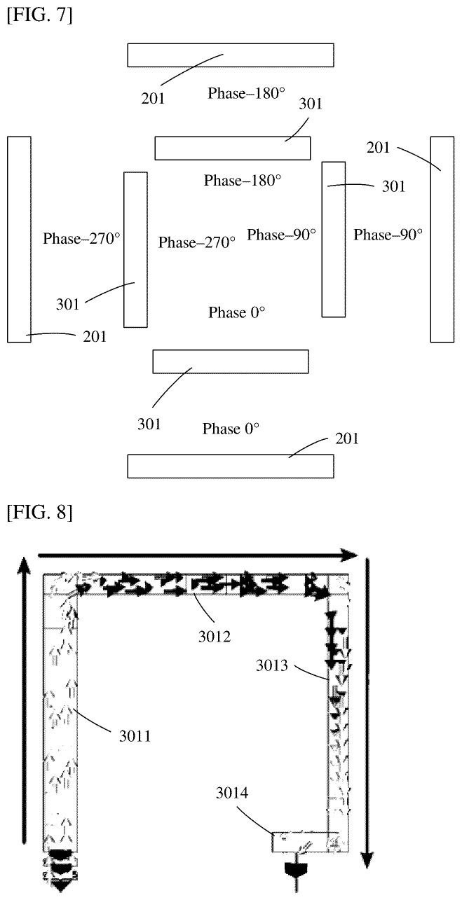

In this scenario, there may be four first antenna stubs 201 and four second antenna stubs 301. Correspondingly, each first antenna stub 201 may correspond to one second antenna stub 301. As shown in FIG. 7, in the direction surrounding the preset straight line L, feeding signals of the first antenna stubs 201 have an equal amplitude and a phase difference of 90° in sequence, and in the direction surrounding the preset straight line L, feeding signals of the second antenna stubs 301 have an equal amplitude and a phase difference of 90° in sequence, so that both the first antenna array 20 and the second antenna array 30 can generate circular polarization signals.

Still refer to FIG. 4. The second antenna array 30 may further include a second dielectric pillar 303. A geometric center line of the second dielectric pillar 303 may be collinearly disposed with a geometric center line of the first dielectric pillar 205. The second dielectric pillar 303 is disposed in the first accommodation hole 206, and a plurality of second antenna stubs 301 are disposed on a side wall of the second dielectric pillar 303. The second antenna stub 301 may be fastened and supported through the second dielectric pillar 303, to improve structural stability of the antenna assembly. It may be understood that the second dielectric pillar 303 has a specific dielectric constant. The dielectric constant of the second dielectric pillar 303 may be properly selected based on performance of the second antenna array 30.

An end that is of the second dielectric pillar 303 and that is away from the substrate 10 may be flush with an end that is of the first dielectric pillar 205 and that is away from the substrate, or an end that is of the second dielectric pillar 303 and that is away from the substrate 10 is located in the first accommodation hole 206. Certainly, the end that is of the second dielectric pillar 303 and that is away from the substrate 10 may alternatively extend out of the first accommodation hole 206.

For example, a material of the second dielectric pillar 303 may include an epoxy glass cloth laminate (FR-4), epoxy resin, or the like. In an implementation in which the material of the second dielectric pillar 303 is the epoxy glass cloth laminate, the second dielectric pillar 303 has a small dielectric constant, to improve impedance matching performance of the second antenna array 30, and further increase a gain of the second antenna array 30.

For example, the second dielectric pillar 303 may be cylindrical, and correspondingly, the second antenna stubs 301 may be distributed on the side wall of the second dielectric pillar 303 around the preset straight line L at equal central angles, so that central angles between any two adjacent second antenna stubs 301 are equal. Certainly, the second dielectric pillar 303 may alternatively be prismatic, and correspondingly, each second antenna stub 301 may be disposed on a side surface that is of the second dielectric pillar 303 and that is parallel to the preset straight line L. For example, in an implementation in which there are four second antenna stubs 301, the second dielectric pillar 303 may be cuboid, and each second antenna stub 301 is disposed on a surface that is of the second dielectric pillar 303 and that is parallel to the preset straight line L.

In the foregoing implementation, the second antenna stubs 301 may be formed on the side wall of the second dielectric pillar 303 through electroplating, deposition, or the like. Certainly, the second antenna stub 301 may alternatively be attached to the side wall of the second dielectric pillar 303.

In the foregoing implementation, the geometric center line of the second dielectric pillar 303 is collinear with the preset straight line L. In other words, the geometric center line of the second dielectric pillar 303, a geometric center line of the first accommodation hole 206, and the geometric center line of the first dielectric pillar 205 are collinearly disposed. In this way, a distance between each second antenna stub 301 and the side wall of the first dielectric pillar 205 may be equal, that is, a distance between each first antenna stub 201 and a corresponding second antenna stub 301 is equal.

In some embodiments, the first antenna stubs 201 are centrosymmetric relative to the geometric center line of the first dielectric pillar 205, and the second antenna stubs 301 are centrosymmetric relative to the geometric center line of the first dielectric pillar 205. In this way, the first antenna stubs 201 and the second antenna stubs 301 are evenly arranged.

In some implementations, each second antenna stub 301 corresponds to one first antenna stub 201. A smaller distance between the first antenna stub 201 and the second antenna stub 301 that correspond to each other indicates more serious mutual coupling between the first antenna stub 201 and the second antenna stub 301. To avoid affecting axial ratios and resonance of the first antenna stub 201 and the second antenna stub 301 due to an excessively small distance between the first antenna stub 201 and the second antenna stub 301 that correspond to each other, a minimum distance between the first antenna stub 201 and the second antenna stub 301 that correspond to each other is greater than or equal to 1 mm (for example, 1 mm, 5 mm, or 10 mm).

Still refer to FIG. 6. The second antenna stub 301 may extend in a curved or bent shape on the second dielectric pillar 303. In this way, space occupied by the second antenna stub 301 can be reduced while it is ensured that the second antenna stub 301 has a specific length in an extension direction, so that a volume of the second dielectric pillar 303 can be reduced, to facilitate miniaturization of the antenna assembly.

For example, the second antenna stub 301 may include a sixth section 3011 extending in a direction parallel to the preset straight line L, a seventh section 3012 extending in a direction perpendicular to the preset straight line L, and an eighth section 3013 extending in the direction parallel to the preset straight line L. The sixth section 3011, the seventh section 3012, and the eighth section 3013 are sequentially connected to each other, and the sixth section 3011 and the eighth section 3013 are located between the seventh section 3012 and the substrate 10. In an embodiment, the second antenna stub 301 further includes a ninth section 3014 extending in the direction perpendicular to the preset straight line L. The ninth section 3014 may be connected to and extend from an end of the eighth section 3013, and is located between the sixth section 3011 and the eighth section 3013. An end that is of the sixth section 3011 and that is close to the substrate 10 may be a second feed end, an end that is of the sixth section 3011 and that is away from the substrate 10 is connected to an end of the seventh section 3012, and an end that is of the seventh section 3012 and that is away from the sixth section 3011 is connected to an end that is of the eighth section 3013 and that is away from the substrate 10. In an embodiment, the eighth section 3013 may be used as a second open end of the second antenna stub 301. In an embodiment, an end that is of the eighth section 3013 and that is close to the substrate 10 is connected to an end that is of the ninth section 3014 and that is away from the sixth section 3011. Correspondingly, an end that is of the ninth section 3014 and that is away from the eighth section 3013 may be used as a second open end, and the second open end and the conductive grounding layer 101 on the substrate 10 are spaced from each other. In an embodiment, the second open end of the second antenna stub 301 and the conductive grounding layer 101 on the substrate 10 are spaced from each other, and are coupled through a component. In an embodiment, the second open end of the second antenna stub 301 and the conductive grounding layer 101 on the substrate 10 are spaced from each other, and are not coupled through a component. In this way, a second antenna stub 301 including a plurality of sections is bent inward, so that space occupied by the second antenna stub 301 can be further reduced.

In the foregoing implementation, a total length of the second antenna stub 301 ranges from 45 mm to 70 mm (for example, 45 mm, 62.1 mm, or 70 mm). The total length of the second antenna stub 301 may be a shortest distance between an end of the second antenna stub 301 at the second feed end and an end of the second antenna stub 301 at the second open end, namely, a length of a codirectional current when the second antenna stub 301 radiates a signal outward.

In the foregoing implementation, a length d5 of the sixth section 3011 may range from 19 mm to 22 mm (for example, 19 mm, 20.5 mm, or 22 mm), a length d6 of the seventh section 3012 may range from 17 mm to 20 mm (for example, 17 mm, 18.5 mm, or 20 mm), a length d8 of the eighth section 3013 may range from 16 mm to 19 mm (for example, 16 mm, 17.5 mm, or 19 mm), and a length d7 of the ninth section 3014 may range from 4 mm to 6 mm (for example, 4 mm, 5.6 mm, or 6 mm).

Still refer to FIG. 4. In some embodiments, each second antenna stub 301 corresponds to one first antenna stub 201. In the first antenna stub 201 and the second antenna stub 301 that correspond to each other, the first feed end is closer to the second feed end than the first open end, and the first open end is closer to the second open end than the second feed end. In this way, currents on the first antenna stub 201 and the second antenna stub 301 that correspond to each other are codirectional currents.

It may be understood that the second antenna stub 301 and the first antenna stub 201 that correspond to each other may be two antenna stubs that are parallel to and close to each other on planes on which the second antenna stub 301 and first antenna stub 201 are located.

In some embodiments, in two adjacent first antenna stubs 201, a first open end of a preceding first antenna stub 201 is disposed close to a first feed end of a following first antenna stub 201. In two adjacent second antenna stubs 301, a second open end of a preceding second antenna stub 301 is disposed close to a second feed end of a following second antenna stub 301. In this way, the first antenna stubs 201 are sequentially disposed end to end in a direction surrounding the geometric center line of the first dielectric pillar 205, and a current on the first antenna array 20 is disposed around a geometric center of the first dielectric pillar 205 (the current on the first antenna array 20 is set clockwise or counterclockwise around the geometric center of the first dielectric pillar 205). Similarly, the second antenna stubs 301 are sequentially disposed end to end, the second antenna stubs 301 are sequentially disposed end to end in the direction surrounding the geometric center line of the first dielectric pillar 205, and a current on the second antenna array 30 is disposed around the geometric center of the first dielectric pillar 205 (the current on the second antenna array 30 is set clockwise or counterclockwise around the geometric center of the first dielectric pillar 205). In an implementation in which the first feed end is disposed close to the second feed end and the first end is disposed close to the second end in the first antenna stub 201 and the second antenna stub 301 that correspond to each other, currents on the first antenna array 20 and the second antenna array 30 may be codirectional (for example, both are set clockwise or counterclockwise around the geometric center of the first dielectric pillar 205).

In the foregoing implementation, the antenna assembly may further include a third capacitor 302. There are a plurality of third capacitors 302. The second feed end of each second antenna stub 301 is electrically coupled to one third capacitor 302. In other words, the corresponding second antenna stub 301 is fed through the third capacitor 302. In this way, the third capacitor 302 may adjust current distribution on the second antenna stub 301, so that a current on the second antenna stub 301 is a codirectional current, and an amplitude of the current on the second antenna stub 301 gradually increases from the second feed end to a middle part or an approximately middle part of the second antenna stub 301 in the extension direction. In addition, the amplitude of the current on the second antenna stub 301 may also gradually increase from the second open end to the middle part or the approximately middle part of the second antenna stub 301 in the extension direction. A current strong point is located in the middle part of the second antenna stub 301, so that the second antenna stub 301 operates in a differential mode. The middle part of the second antenna stub 301 is mainly used for signal transmission and reception. A large amplitude of a current on the middle part of the second antenna stub 301 can increase gains of the second antenna stub 301 and the antenna assembly, so that performance of the antenna assembly is improved.

FIG. 8 shows a distribution diagram of currents on the second antenna stub 301. In the figure, a density of arrows representing the currents is positively correlated with current amplitudes. It can be learned from FIG. 8 that the third capacitor 302 may adjust current distribution on the second antenna stub 301, so that amplitudes of currents on the sixth section 3011 and the ninth section 3014 are small, and an amplitude of a current on the seventh section 3012 is large. In other words, the amplitude of the current on the second antenna stub 301 gradually increases from the second feed end to the middle or the approximately middle part of the second antenna stub 301 in an extension direction, and the amplitude of the current on the second antenna stub 301 gradually increases from the second open end to the middle or the approximately middle part of the second antenna stub 301 in the extension direction, so that the second antenna stub works operates in a DM mode.

An end that is of the sixth section 3011 and that is close to the substrate 10 is the second feed end of the second antenna stub 301. One electrode plate of the third capacitor 302 is electrically connected to the second feed end, and another electrode plate of the third capacitor 302 may be connected to a second feed device, so that the second feed device may perform feeding on the second antenna stub through the third capacitor 302. For example, the second feed device may include a power splitter, a phase shifter, or the like. Certainly, the second feed device may also include a microstrip line, a coplanar waveguide line, or the like. Through the second feed device, in the direction surrounding the preset straight line L, feeding signals of the second antenna stubs 301 may have an equal amplitude, and the feeding signals have a same phase difference in sequence, to generate a circular polarization signal.

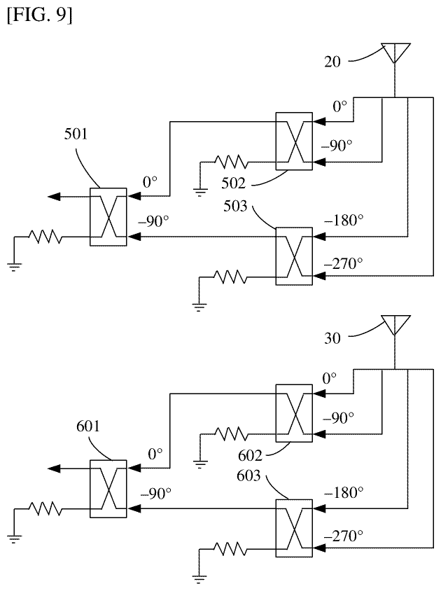

Refer to FIG. 9. In an implementation in which the first feed device and the second feed device each include a phase shifter. The first feed device may include a first primary phase shifter 501, a first secondary phase shifter 502, and a second secondary phase shifter 503. An input end of the first primary phase shifter 501 may be connected to a coaxial cable to receive a feeding signal. After passing through the first primary phase shifter 501, the feeding signal forms two secondary feeding signals with a phase difference of 90°. The two secondary feeding signals are respectively transmitted to the first secondary phase shifter 502 and the second secondary phase shifter 503, signals with a phase difference of 90° are formed at two output ends of the first secondary phase shifter 502, and signals with a phase difference of 90° are respectively formed at two output ends of the second secondary phase shifter 503. In this way, signals output by the two output ends of the first secondary phase shifter 502 and the two output ends of the second secondary phase shifter 503 have a phase difference of 90° in sequence. The two output ends of the first secondary phase shifter 502 and the two output ends of the second secondary phase shifter 503 are respectively connected to the first antenna stubs in the first antenna array 20, so that the first antenna array 20 generates a circular polarization signal.

Similarly, the second feed device may include a second primary phase shifter 601, a third secondary phase shifter 602, and a fourth secondary phase shifter 603. An input end of the second primary phase shifter 601 may be connected to a coaxial cable to receive a feeding signal. After passing through the second primary phase shifter 601, the feeding signal forms two secondary feeding signals with a phase difference of 90°. The two secondary feeding signals are respectively transmitted to the third secondary phase shifter 602 and the fourth secondary phase shifter 603, signals with a phase difference of 90° are formed at two output ends of the third secondary phase shifter 602, and signals with a phase difference of 90° are respectively formed at two output ends of the fourth secondary phase shifter 603. In this way, signals output by the two output ends of the third secondary phase shifter 602 and the two output ends of the fourth secondary phase shifter 603 have a phase difference of 90° in sequence. The two output ends of the third secondary phase shifter 602 and the two output ends of the fourth secondary phase shifter 603 are respectively connected to the second antenna stubs in the second antenna array 30, so that the second antenna array 30 generates a circular polarization signal.

It may be understood that, in this embodiment of this application, the antenna assembly may further include a first feed source and a second feed source. A first feed end of each of the plurality of first antenna stubs 201 is coupled to the first feed source, and the first antenna stub 201 is configured to receive a signal of the first feed source for radiation on a first operating frequency band. Similarly, a second feed end of each of the plurality of second antenna stubs 301 is coupled to the second feed source, and the second antenna stub 301 is configured to receive a signal of the second feed source for radiation on a second operating frequency band. For example, the first feed source may be coupled to each of the first antenna stubs 201 through the first feed device, and the second feed source may be coupled to each of the second antenna stubs 301 through the second feed device.

The first feed source and the second feed source may include devices that can provide signals, such as coaxial cables. The first feed source and the second feed source may be the same or different. This is not limited in embodiments of this application. In an implementation in which the first feed source and the second feed source include a coaxial cable, the first feed source and the second feed source are the same, that is, the first feed source and the second feed source may be a same coaxial cable, or the first feed source and the second feed source are different, in this case, the first feed source and the second feed source are different coaxial cables.

It may be understood that the third capacitor 302 may alternatively be disposed on the second dielectric pillar 303, and the third capacitor 302 may be disposed between the second feed end and the substrate 10, to improve structural compactness of the antenna assembly. Certainly, the third capacitor 302 may alternatively be disposed on the substrate 10. Correspondingly, the third capacitor 302 may be connected to a corresponding second feed end through a conducting wire. The second feed device may be disposed on the substrate 10, and may transmit a feeding signal to the feed device through a coaxial cable. The second feed device simultaneously performs feeding on each second antenna stub 301, so that feeding signals of the second antenna stubs 301 have an equal amplitude, and the feeding signals have a same phase difference in sequence.

A capacitance value of the third capacitor 302 may range from 0.1 pF to 0.5 pF. For example, the capacitance value of the third capacitor 302 may be 0.1 pF, 0.25 pF, 0.5 pF, or the like. A resonance frequency of the second antenna stub 301 gradually decreases as the capacitance value of the third capacitor 302 increases. The capacitance value of the third capacitor 302 ranges from 0.1 pF to 0.5 pF, so that an excessively low resonance frequency of the second antenna stub 301 due to an excessively large capacitance value of the third capacitor 302 can be avoided while it is ensured that the second antenna stub 301 operates in the DM mode.

Still refer to FIG. 4 and FIG. 6. The antenna assembly may further include a fourth capacitor 305. The fourth capacitor 305 is disposed between the second open end and the conductive grounding layer 101. One electrode plate of the fourth capacitor 305 is connected to the second open end, and another electrode plate of the fourth capacitor 305 is electrically connected to the conductive grounding layer 101. The fourth capacitor 305 may be disposed on the second dielectric pillar 303, and the fourth capacitor 305 may be disposed between the ninth section 3014 and the substrate 10, to further improve structural compactness of the antenna assembly. Certainly, the fourth capacitor 305 may alternatively be disposed on the substrate 10. In this way, a resonance frequency of a second antenna stub 301 connected to the fourth capacitor 305 can be reduced through the fourth capacitor 305, so that a size (a length in the extension direction) of the second antenna stub 301 can be reduced, to implement miniaturization of the antenna assembly.

A capacitance value of the fourth capacitor 305 may range from 0.1 pF to 0.5 pF. For example, the capacitance value of the fourth capacitor 305 may be 0.1 pF, 0.25 pF, 0.5 pF, or the like. It may be understood that if the capacitance value of the fourth capacitor 305 is excessively large, impedance matching of the second antenna stub 301 is difficult. The capacitance value of the fourth capacitor 305 ranges from 0.1 pF to 0.5 pF, so that impedance matching difficulty of the second antenna stub 301 is reduced while it is ensured that the second antenna stub 301 operates in the DM mode and the size of the second antenna stub 301 is reduced through the fourth capacitor 305.

In an implementation in which the antenna assembly includes the inductor 204, the inductor 204 may alternatively be disposed between the second feed device and the third capacitor 302. In other words, the second feed device is connected to the third capacitor 302 through the inductor 204. The resonance frequency of the second antenna stub 301 can be reduced through the inductor 204, to reduce a size of the second antenna stub 301.

For example, an inductance value of the inductor may be 10 nH to 15 nH (10 nH, 12.5 nH, 15 nH, or the like), to avoid an excessively large or small inductance value of the inductor while it is ensured that the resonance frequency of the second antenna stub 301 is reduced to reduce the size of the second antenna stub 301. The inductor 204 may be disposed on the second dielectric pillar 303. Certainly, the inductor 204 may alternatively be disposed on the substrate 10.

In the foregoing implementation, the second accommodation hole 304 may be provided on the second dielectric pillar 303, and a center line of the second accommodation hole 304 and the preset straight line L may be collinearly disposed. In this way, a mass of the second dielectric pillar 303 can be reduced, to implement lightweight of the antenna assembly.

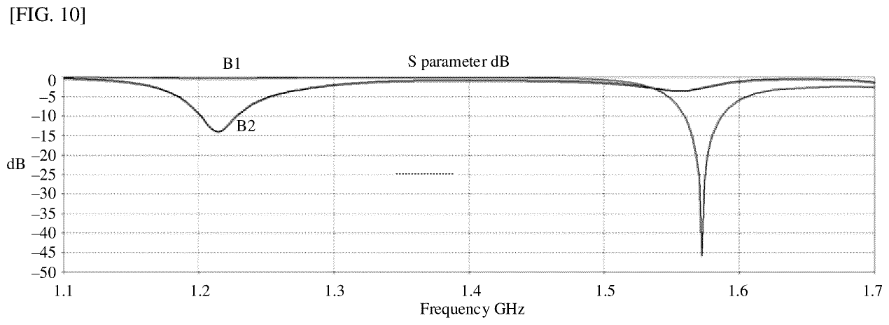

FIG. 10 is an active S11 curve diagram of the first antenna array 20 and the second antenna array 30 operating in a frequency band of a global satellite navigation system (a horizontal coordinate in the figure is a frequency GHz, a vertical coordinate is an S parameter dB, and the S parameter is an active reflection coefficient). A first operating frequency band of the first antenna array 20 is greater than a second operating frequency band of the second antenna array 30 (for example, a resonance frequency of the first antenna array 20 may be 1.58 GHz, and a resonance frequency of the second antenna array 30 may be 1.22 GHz). A curve B1 is an active S11 curve diagram corresponding to the first antenna array 20, and a curve B2 is an active S11 curve diagram corresponding to the second antenna array 30. In this case, the first antenna array 20 and the second antenna array 30 may simultaneously excite two differential mode resonance modes. It can be learned from FIG. 10 that a frequency band of the antenna assembly covers 1.16 GHz to 1.28 GHz and 1.55 GHz to 1.61 GHz, that is, all frequency bands of the global satellite navigation system can be covered, so that a bandwidth of the antenna assembly is increased.

In some implementations, there is a specific difference between the resonance frequency corresponding to the first antenna array 20 and the resonance frequency corresponding to the second antenna array 30, to avoid affecting performance of the antenna assembly. In some implementations, a frequency difference between the resonance frequency (the first operating frequency band of the first antenna stub 201) corresponding to the first antenna array 20 and the resonance frequency (the second operating frequency band of the second antenna stub 301) corresponding to the second antenna array 30 is greater than or equal to 180 MHz.

It may be understood that FIG. 10 corresponds to an embodiment in which the first operating frequency band of the first antenna array 20 is greater than the second operating frequency band of the second antenna array 30. In this way, the first antenna array 20 located outside has a higher operating frequency, is less affected by low-frequency blocking interference, and has wider radiation space, so that high-frequency performance can be improved, and performance of the antenna assembly can be further improved. In another embodiment, the first operating frequency band of the first antenna array 20 may alternatively be less than the first operating frequency band of the second antenna array 30. Operating frequencies of the first antenna array 20 and the second antenna array 30 are not limited in embodiments of this application.

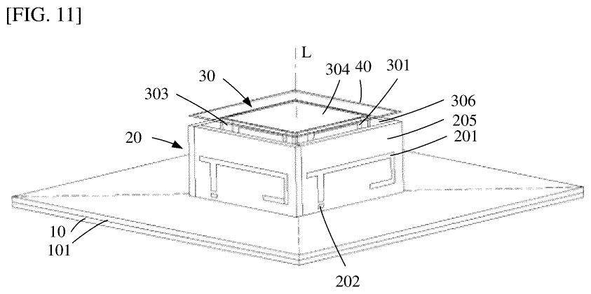

Still refer to FIG. 11. In some implementations, the first antenna array 20 is located at a geometric center of the conductive grounding layer 101. In other words, a geometric center line (for example, the preset straight line L) of the first antenna array 20 coincides with or has a small distance (for example, from 1 mm to 3 mm) from the geometric center of the conductive grounding layer 101, so that the first antenna array 20 is disposed at a middle position of the conductive grounding layer 101. In this way, the antenna assembly is located in a symmetrical environment, to improve a circular polarization effect of the antenna assembly. For example, the conductive grounding layer 101 may be in a square shape, and correspondingly, the geometric center of the square is an intersection point between diagonals of the square. The conductive grounding layer 101 may alternatively be in a circle shape, and correspondingly, a geometric center of the circle is a center of the circle. It may be understood that, in an implementation in which the conductive grounding layer 101 is of an irregular shape, the geometric center of the conductive grounding layer 101 is located at an approximately middle position of the conductive grounding layer 101, that is, distances from the geometric center to an edge of the conductive grounding layer 101 are approximately equal.

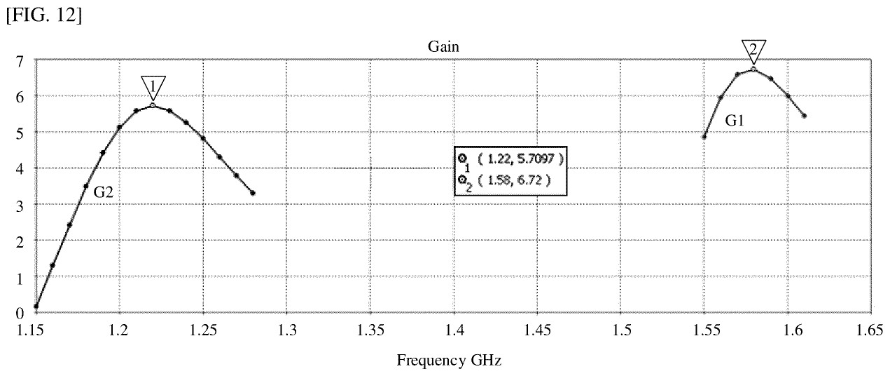

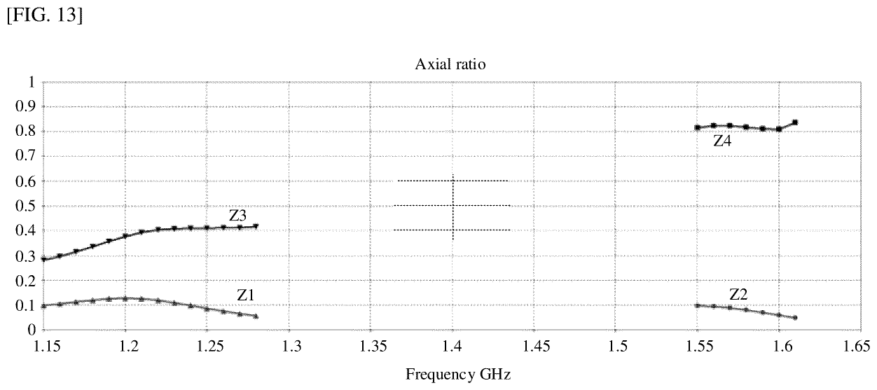

FIG. 12 is a gain diagram of the first antenna array 20 and the second antenna array 30 within ±30° in a zenith direction when the conductive grounding layer 101 is in a square shape and the first antenna array 20 is located at a geometric center of the conductive grounding layer 101 (a horizontal coordinate is a frequency GHz, and a vertical coordinate is a gain). In the figure, G1 is a gain curve corresponding to the first antenna array 20, and G2 is a gain curve corresponding to the second antenna array 30. FIG. 13 is an axial ratio diagram of the first antenna array 20 and the second antenna array 30 (a horizontal coordinate is a frequency GHz, and a vertical coordinate is an axial ratio). An axial ratio curve of the first antenna array 20 in an axial direction (a zenith direction) is Z2, an axial ratio diagram curve of the second antenna array 30 in the zenith direction is Z1, a maximum axial ratio curve of the first antenna array 20 within ±30° in the zenith direction is Z4, and a maximum axial ratio curve of the second antenna array 30 within ±30° in the zenith direction is Z3. It can be learned from FIG. 12 and FIG. 13 that, when the first antenna array 20 and the second antenna array 30 operate in a frequency band of a global satellite navigation system, the first antenna array 20 and the second antenna array 30 each have a high gain, and the first antenna array 20 and the second antenna array 30 each have a small axial ratio, so that the antenna assembly has high positioning precision.

In another implementation, the first antenna array 20 may be spaced from the geometric center of the conductive grounding layer 101 (as shown in FIG. 1). To be specific, a geometric center line (for example, the preset straight line L) of the first antenna array 20 has a large distance to the geometric center of the conductive grounding layer 101. For example, the first antenna array 20 may be disposed at a position close to an edge or a corner of the conductive grounding layer 101. In this way, the antenna assembly has an irregular shape, and can adapt to irregular mounting space, to adapt to mounting space of another device. This improves performance of the antenna assembly in a non-ideal environment. In addition, because each first antenna stub 201 operates in a differential mode, radiation energy of the first antenna stub 201 is strong, and is less affected by an asymmetric switching environment, so that a circular polarization effect of the antenna assembly can still be ensured. For example, the conductive grounding layer 101 may be in a rectangle shape. Correspondingly, a length of a long side of the conductive grounding layer 101 may range from 250 mm to 300 mm (for example, 250 mm, 270 mm, or 300 mm), a length of a short side of the conductive grounding layer 101 may range from 100 mm to 150 mm (for example, 100 mm, 120 mm, or 150 mm), and the geometric center of the first antenna array may be located on one side of an intersection point (center) between diagonals of the rectangle. A distance e8 or e9 between the first dielectric pillar 205 and a side edge of the conductive grounding layer 101 close to the first dielectric pillar 205 may range from 10 mm to 15 mm (for example, 10 mm, 12.5 mm, or 15 mm).

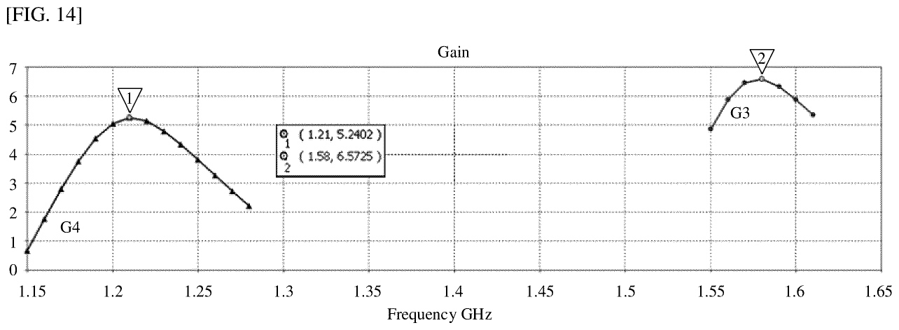

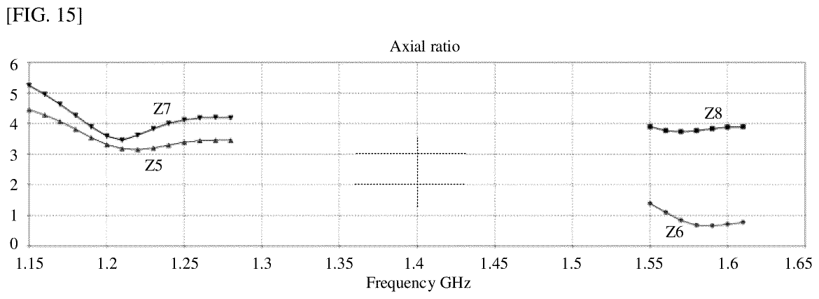

FIG. 14 is a circular polarization gain diagram within ±30° in a zenith direction when the first antenna array 20 is disposed at a position close to an edge or a corner of the conductive grounding layer 101. In the figure, G3 is a gain curve corresponding to the first antenna array 20, and G4 is a gain curve corresponding to the second antenna array 30. FIG. 15 is a maximum axial ratio diagram in a zenith direction and within ±30° in a zenith direction when the first antenna array 20 is disposed at a position close to an edge or a corner of the conductive grounding layer 101. In the figure, Z5 is an axial ratio curve of the second antenna array 30 in the zenith direction, Z6 is an axial ratio curve of the first antenna array 20 in the zenith direction, Z7 is a maximum axial ratio curve of the second antenna array 30 within ±30° in the zenith direction, and Z8 is a maximum axial ratio curve of the first antenna array 20 within ±30° in the zenith direction. It can be learned from FIG. 14 and FIG. 15 that when the first antenna array 20 is disposed at a position close to a corner of the conductive grounding layer 101 (in a non-ideal environment), the first antenna array 20 and the second antenna array 30 still have a high gain and a small axial ratio, so that positioning precision of the antenna assembly is high.

Still refer to FIG. 1. In this scenario, the antenna assembly further includes a conductive ring 40. The conductive ring 40 may be disposed on a side that is of the first antenna array 20 and the second antenna array 30 and that is away from the substrate 10. The conductive ring 40 and the first antenna array 20 are spaced from each other. The first antenna stub 201 is configured to couple a signal to the conductive ring 40. A geometric center line of the conductive ring 40 and the preset straight line L may be collinearly disposed, and the conductive ring 40 may be in a shape like a circle or a square.

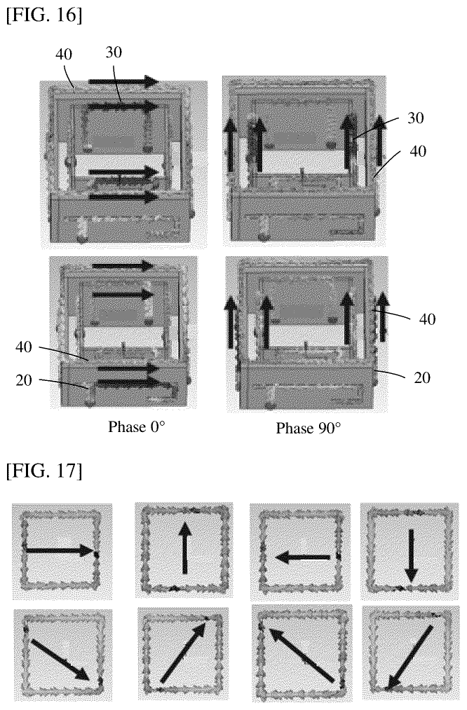

As shown in FIG. 16, during use, a direction of a current on the conductive ring 40 is the same as a direction of the current on the first antenna stub 201 and the second antenna stub 301. As shown in FIG. 17, a first row in the figure is a distribution diagram of currents on the conductive ring 40 when the second antenna array 30 couples a signal to the conductive ring 40, and a second row in the figure is a distribution diagram of currents on the conductive ring 40 when the first antenna array 20 couples a signal to the conductive ring 40. It can be learned from FIG. 17 that a right-hand circular polarization signal is generated on the conductive ring 40. In terms of far-field performance, the conductive ring 40 may have a co-directional superposition effect. This increases gains of the first antenna array 20 and the second antenna array 30. In addition, a circularly polarized electromagnetic wave radiated by the conductive ring 40 is rotated in a same direction as circularly polarized electromagnetic waves radiated by the first antenna array 20 and the second antenna array 30, and a current on the conductive ring 40 and currents on the first antenna array 20 and the second antenna array 30 have a same phase change and polarization. In this way, circular polarization radiation of the first antenna array 20 and the second antenna array 30 on the rectangular conductive grounding layer 101 is purer, and deterioration of circular polarization radiation of the first antenna array 20 and the second antenna array 30 caused by an asymmetric environment is corrected to a specific extent. Therefore, an axial ratio of the first antenna array 20 and an axial ratio of the second antenna array 30 can be reduced.

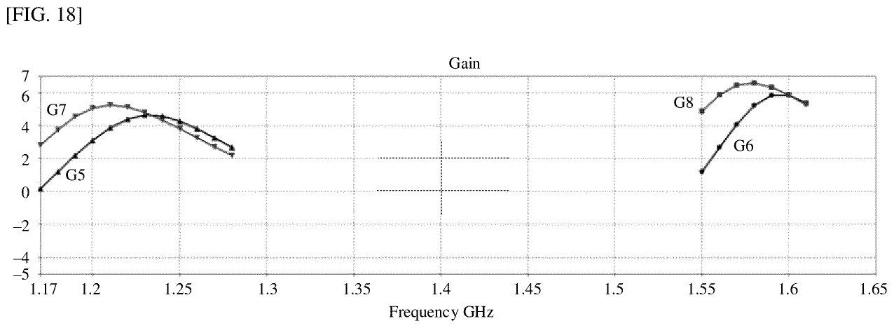

FIG. 18 is a comparison diagram of gains (maximum gains within ±30° in a zenith direction) between a case in which the conductive ring 40 is disposed and a case in which no conductive ring 40 is disposed if the first antenna array 20 and a geometric center of the conductive grounding layer 101 are spaced from each other, and the first antenna array 20 is close to a vertex of the rectangular conductive grounding layer 101. G5 is a gain curve of the second antenna array 30 when no conductive ring 40 is disposed, G6 is a gain curve of the first antenna array 20 when no conductive ring 40 is disposed, G7 is a gain curve of the second antenna array 30 when the conductive ring 40 is disposed, and G8 is a gain curve of the first antenna array 20 when the conductive ring 40 is disposed. It can be learned from FIG. 18 that gains of the first antenna array 20 and the second antenna array 30 are significantly increased after the conductive ring 40 is disposed.

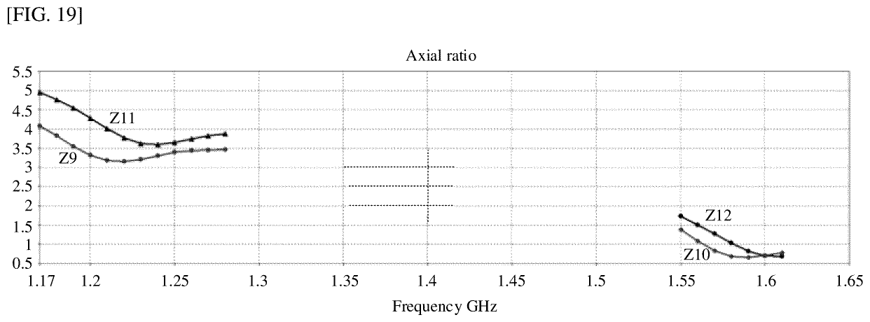

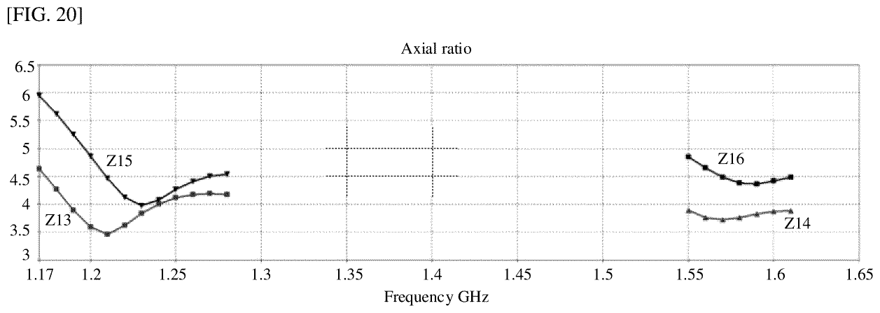

FIG. 19 is a comparison diagram of axial ratios (in a zenith direction) between a case in which the conductive ring 40 is disposed and a case in which no conductive ring 40 is disposed if the first antenna array 20 and a geometric center of the conductive grounding layer 101 are spaced from each other, and the first antenna array 20 is close to a vertex of the rectangular conductive grounding layer 101. Z9 is an axial ratio diagram of the second antenna array 30 when the conductive ring 40 is disposed, Z10 is an axial ratio diagram of the first antenna array 20 when the conductive ring 40 is disposed, Z11 is an axial ratio diagram of the second antenna array 30 when no conductive ring 40 is disposed, and Z12 is an axial ratio diagram of the first antenna array 20 when no conductive ring 40 is disposed. FIG. 20 is a comparison diagram of axial ratios (maximum axial ratios within ±30° in a zenith direction) between a case in which the conductive ring 40 is disposed and a case in which the conductive ring 40 is not disposed. Z13 is an axial ratio diagram of the second antenna array 30 when the conductive ring 40 is disposed, Z14 is an axial ratio diagram of the first antenna array 20 when the conductive ring 40 is disposed, Z15 is an axial ratio diagram of the second antenna array 30 when no conductive ring 40 is disposed, and Z16 is an axial ratio diagram of the first antenna array 20 when no conductive ring 40 is disposed. It can be learned from FIG. 19 and FIG. 20 that after the conductive ring 40 is disposed, axial ratios of the first antenna array 20 and the second antenna array 30 are significantly reduced.

Still refer to FIG. 1 and FIG. 2. In the foregoing implementation, a projection of the first dielectric pillar 205 on the substrate 10 may be a square. Correspondingly, a shape of the conductive ring may also be a square, and a side length of the conductive ring 40 may not be greater than 50 mm (for example, the side length of the conductive ring 40 is 50 mm, 45 mm, 20 mm, or the like), to ensure that a current on the conductive ring 40 and currents on the first antenna array 20 and the second antenna array 30 are codirectional. A greater distance e2 between the conductive ring 40 and the first antenna array 20 indicates a smaller effect of the conductive ring 40 on optimization of an axial ratio of the first antenna array 20. For example, the distance e2 between the conductive ring 40 and the first antenna stub 201 may be less than or equal to 11 mm (for example, 11 mm, 5 mm, or 3 mm), so that the axial ratio of the first antenna array 20 is less than 4, and the antenna assembly has high positioning precision. The distance e2 between the conductive ring 40 and the first antenna stub 201 is a minimum distance between the conductive ring 40 and the first antenna stub 201. Similarly, a minimum distance between the conductive ring 40 and the second antenna stub 301 may be less than or equal to 11 mm (for example, 11 mm, 5 mm, or 3 mm), so that the conductive ring 40 also has an axial ratio optimization effect on the second antenna array 30.

It may be understood that the conductive ring 40 may alternatively be disposed on a side that is of the second antenna array 30 and that is away from the substrate 10 (disposed facing the second antenna array 30). Alternatively, the conductive ring 40 is disposed on a side that is of each of the first antenna array 20 and the second antenna array 30 and that is away from the substrate 10. This is not limited in this scenario. It may be understood that in an implementation in which the conductive ring 40 is disposed on a side that is of the first antenna array 20 and that is away from the substrate 10 (that is, the conductive ring 40 is opposite to the first antenna array 20), the conductive ring 40 mainly improves performance of the first antenna array 20. In an implementation in which the conductive ring 40 is disposed on a side that is of the second antenna array 30 and that is away from the substrate 10 (that is, the conductive ring 40 is opposite to the second antenna array 30), the conductive ring 40 mainly improves performance of the second antenna array 30.

In this scenario, the antenna assembly may further include a dielectric slab. The dielectric slab and the substrate 10 are parallel to or spaced from each other. The conductive ring 40 is disposed on the dielectric slab. In this way, the conductive ring 40 may be supported and fastened through the dielectric slab. For example, a material of the conductive ring 40 may include a metal such as copper or aluminum. Certainly, the material of the conductive ring 40 may alternatively include another non-metal conductive material. In an implementation in which the conductive ring 40 includes a metal, the conductive ring 40 may be formed on the dielectric slab through electroplating, deposition, or the like. Certainly, the conductive ring 40 may be attached to the dielectric slab. In an implementation in which the conductive ring 40 includes a non-metal conductive material, the conductive ring 40 may be formed on the dielectric slab through coating or the like.

In an implementation in which the antenna assembly is disposed on a telematics box, the telematics box may include a housing. A mounting cavity is enclosed by the housing, and the substrate 10, the first antenna array 20, and the second antenna array 30 are all disposed in the mounting cavity. Correspondingly, the dielectric slab may also be disposed in the mounting cavity and connected to the housing, to fasten the dielectric slab. Certainly, in another implementation, the conductive ring 40 may be directly disposed on the housing. In this case, the dielectric slab does not need to be disposed, to reduce a volume and a mass of the telematics box.

### Scenario 2

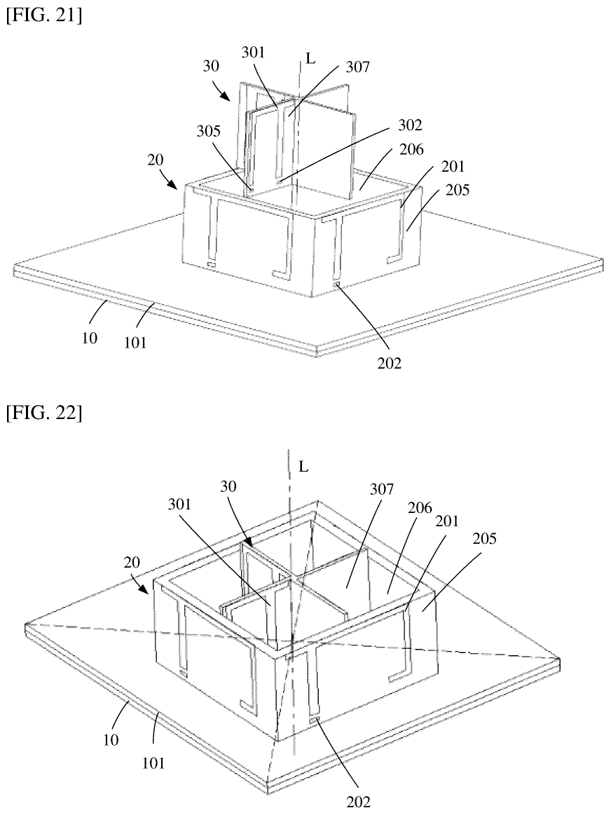

A difference between this scenario and Scenario 1 lies in that, as shown in FIG. 21 and FIG. 22, each second antenna stub 301 is disposed in a first accommodation hole 206, and planes on which the second antenna stubs 301 are located intersect at a geometric center line of a first dielectric pillar 205. When the geometric center line of the first dielectric pillar 205 coincides with the preset straight line L, each second antenna stub 301 extends toward the preset straight line L, that is, each second antenna stub 301 extends toward a middle part of the first accommodation hole 206. This may increase a distance between the second antenna stub 301 and a side wall of the first dielectric pillar 205, and further increase a distance between a first antenna stub 201 and the second antenna stub 301, to improve isolation between the first antenna stub 201 and the second antenna stub 301.

In some implementations, the second antenna array 30 includes a plurality of dielectric plates 307 disposed in the first accommodation hole 206, and each second antenna stub 301 is disposed on one dielectric plate 307. Each second antenna stub 301 may be supported and fastened through the dielectric plate 307.

Planes on which the second antenna stubs 301 are located may be disposed around the preset straight line L at equal central angles, that is, an included angle between planes on which any two adjacent second antenna stubs 301 are located is equal. Correspondingly, the dielectric plates 307 are disposed around the preset straight line L at equal circular angles. An end that is of each dielectric plate 307 and that is close to the preset straight line L is connected. For example, the dielectric plates 307 may be connected to each other by using an adhesive. Certainly, the dielectric plates 307 may alternatively form an integrated structure by using a process such as injection molding.

Each dielectric plate 307 corresponds to one first antenna stub 201. For example, there may be four first antenna stubs 201 and four second antenna stubs 301. Correspondingly, a cross section of the first dielectric pillar 205 may be in a square shape, a side wall of the first dielectric pillar 205 includes four side surfaces, and each side surface corresponds to one side of the square. Correspondingly, there are four dielectric plates 307, and each dielectric plate 307 corresponds to one side surface and is perpendicular to the side surface. In other words, a “grid”-shaped structure are enclosed by the first dielectric pillar 205 and the dielectric plates 307. Certainly, there may be six first antenna stubs 201 and six second antenna stubs 301. Correspondingly, a cross section of the first dielectric pillar 205 may be in a regular hexagon shape, a side wall of the first dielectric pillar 205 includes six side surfaces, and each side surface corresponds to one side of the hexagon. Correspondingly, there are six dielectric plates 307, and each dielectric plate 307 corresponds to one side surface and is perpendicular to the side surface.

In the foregoing implementations, each second antenna stub 301 corresponds to one first antenna stub 201. In the second antenna stub 301 and the first antenna stub 201 that correspond to each other, a second feed end of the second antenna stub 301 is disposed away from the first antenna stub 201. In other words, the second feed end of each second antenna stub 301 is disposed close to the preset straight line L. In this way, a distance between the second feed end and the corresponding first antenna stub 201 can be increased, to further improve isolation between the first antenna stub 201 and the second antenna stub 301.

It may be understood that the first antenna stub 201 and the second antenna stub 301 that correspond to each other may be two antenna stubs that are perpendicular to and close to each other on planes on which the first antenna stub 201 and the second antenna stub 301 are located.

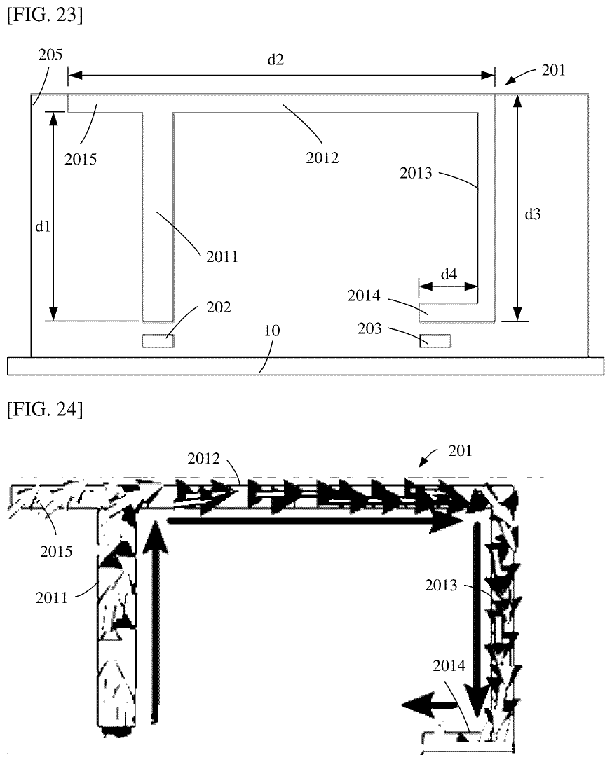

As shown in FIG. 23, in this scenario, a structure of the first antenna array 20 may be approximately the same as a structure of the first antenna array 20 in Scenario 1, and sizes of sections in the first antenna stub 201 may be different from those in Scenario 1. For example, a total length of the first antenna stub 201 ranges from 50 mm to 73 mm (for example, 50 mm, 62.7 mm, or 73 mm). For example, a length d1 of a first section 2011 may range from 12 mm to 17 mm (for example, 12 mm, 15 mm, or 17 mm), a sum of lengths d2 of a second section 2012 and a fifth section 2015 may range from 30 mm to 38 mm (for example, 30 mm, 34.5 mm, or 38 mm), a length d3 of a third section 2013 may range from 15 mm to 20 mm (for example, 15 mm, 18.5 mm, or 20 mm), and a length d4 of a fourth section 2014 may range from 3 mm to 8 mm (for example, 3 mm, 4.7 mm, or 8 mm).

FIG. 24 is a distribution diagram of currents on the first antenna stub. It can be learned from FIG. 24 that the first capacitor 202 may make the currents on the first antenna stub 201 be codirectional currents, and enable an amplitude of a current on the first section 2011 to be less than an amplitude of a current on the second section 2012, and enable an amplitude of a current on the fourth section 2014 to be less than an amplitude of a current on the second section 2012, so that the first antenna stub 201 operates in a differential mode.

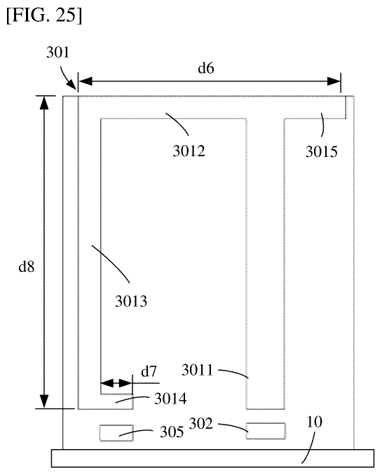

Refer to FIG. 25. A structure of the second antenna stub 301 may include a sixth section 3011, a seventh section 3012, and an eighth section 3013. The sixth section 3011, the seventh section 3012, and the eighth section 3013 are sequentially connected to each other, and the sixth section 3011 and the eighth section 3013 are located between the seventh section 3012 and the substrate 10. In an embodiment, the second antenna stub 301 further includes a ninth section 3014. The ninth section 3014 may be connected to and extend from an end of the eighth section 3013, and is located between the sixth section 3011 and the eighth section 3013. The sixth section 3011 and the eighth section 3013 are both parallel to the substrate 10, the seventh section 3012 and the ninth section 3014 are located between the sixth section 3011 and the eighth section 3013, an end that is of the sixth section 3011 and that is away from the substrate 10 is connected to an end close to the seventh section 3012, an end that is of the seventh section 3012 and that is away from the sixth section 3011 is connected to an end that is of the eighth section 3013 and that is away from the substrate 10, and an end that is of the eighth section 3013 and that is close to the substrate is connected to an end that is of the ninth section 3014 and that is away from the sixth section 3011. The end that is of the sixth section 3011 and that is close to the substrate 10 may be the second feed end. In an embodiment, the eighth section 3013 may be used as a second open end of the second antenna stub 301. In an embodiment, an end that is of the eighth section 3013 and that is close to the substrate 10 is connected to an end that is of the ninth section 3014 and that is away from the sixth section 3011. Correspondingly, an end that is of the ninth section 3014 and that is away from the eighth section 3013 may be used as a second open end, and the second open end and the conductive grounding layer 101 on the substrate 10 are spaced from each other. In an embodiment, the second open end of the second antenna stub 301 and the conductive grounding layer 101 on the substrate 10 are spaced from each other, and are coupled through a component. In an embodiment, the second open end of the second antenna stub 301 and the conductive grounding layer 101 on the substrate 10 are spaced from each other, and are not coupled through a component. A tenth section 3015 extending away from the sixth section 3011 may be disposed at the end that is of the seventh section 3012 and that is close to the sixth section 3011, and the tenth section 3015 may be configured to detect the second antenna stub 301.

In some embodiments, a total length of the second antenna stub 301 ranges from 40 mm to 62 mm (for example, 40 mm, 41.5 mm, 61.5 mm, or 62 mm). For example, a length d7 of the ninth section 3014 may range from 1 mm to 5 mm (for example, 1 mm, 3 mm, or 5 mm), and a length d8 of the eighth section 3013 may range from 19 mm to 22 mm (for example, 19 mm, 20.5 mm, or 22 mm). A sum of lengths d6 of the seventh section 3012 and the tenth section 3015 may range from 15 mm to 20 mm (for example, 15 mm, 17.5 mm, or 20 mm).

In the foregoing implementation, a third capacitor 302 may be disposed between an end that is of the sixth section 3011 and that is close to the substrate 10 and the substrate 10, and the third capacitor 302 may be located on the dielectric plate 307. One end of the third capacitor 302 is electrically connected to the second feed end, and the other end of the third capacitor 302 may be configured to connect to the second feed device. In an implementation in which the second antenna array 30 includes a fourth capacitor 305, the fourth capacitor 305 may be disposed between the ninth section 3014 and the substrate 10, one end of the fourth capacitor 305 is electrically connected to the second open end, and the other end of the fourth capacitor 305 may be electrically connected to the conductive grounding layer 101.

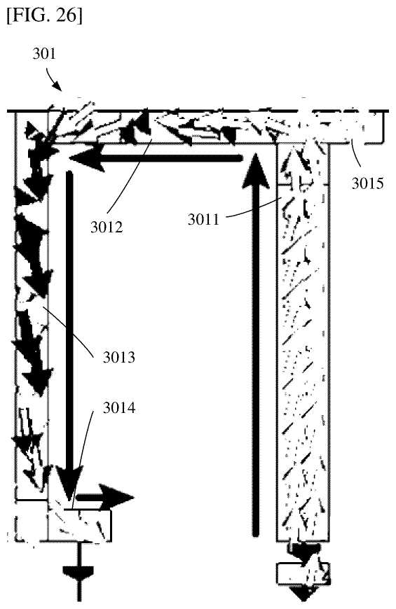

FIG. 26 is a distribution diagram of currents on the second antenna stub 301. It can be learned from FIG. 26 that the third capacitor 302 makes an amplitude of a current on the sixth section 3011 be less than an amplitude of a current on the seventh section 3012, and an amplitude of a current on the ninth section 3014 be less than an amplitude of a current on the eighth section 3013, so that the second antenna stub 301 is a differential mode antenna.

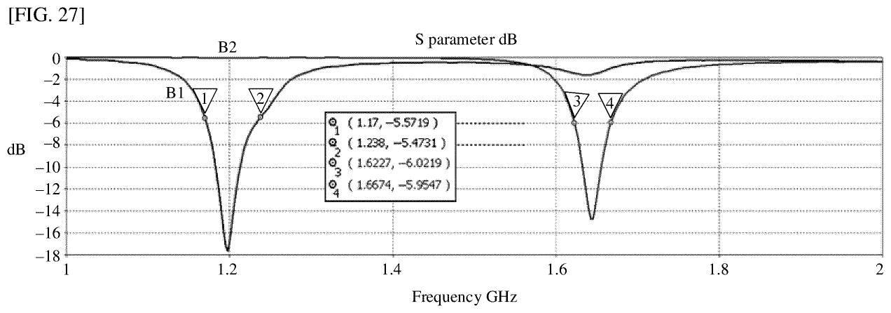

FIG. 27 is an active S11 curve diagram of the first antenna array 20 and the second antenna array 30 operating in a frequency band of a global satellite navigation system. A first operating frequency band of the first antenna array 20 is lower than a second operating frequency band of the second antenna array 30 (for example, the first operating frequency band of the first antenna array 20 may be 1.22 GHz, and the first operating frequency band of the second antenna array 30 may be 1.58 GHz). A curve B1 is an active S11 curve diagram corresponding to the first antenna array 20, and a curve B2 is an active S11 curve diagram corresponding to the second antenna array 30. In this case, the first antenna array 20 and the second antenna array 30 may separately excite two differential mode resonance modes. It can be learned from FIG. 27 that the antenna assembly in this case can cover L1, L2, L5, B2, and B1 frequency bands of the global satellite navigation system.

It may be understood that, in another implementation, the first operating frequency band of the first antenna array 20 may be higher than the second operating frequency band of the second antenna array 30. A value relationship between the first operating frequency band of the first antenna array 20 and the second operating frequency band of the second antenna array 30 is not limited in this scenario.

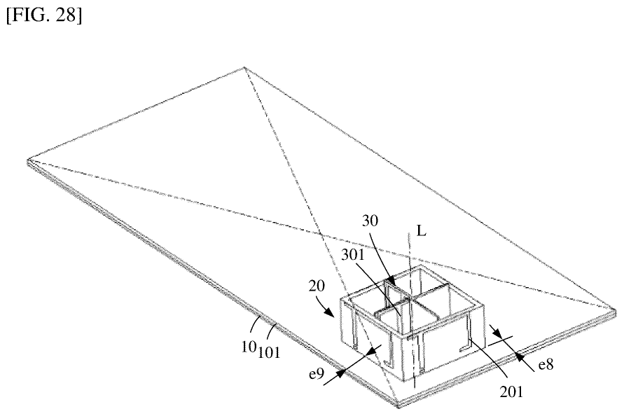

As shown in FIG. 28, in some implementations, the first antenna array 20 and a geometric center of the conductive grounding layer 101 may be spaced from each other. For example, the first antenna array 20 may be disposed at a position close to an edge or a corner of the conductive grounding layer 101. In this way, the antenna assembly has an irregular shape, and can adapt to irregular mounting space, to adapt to mounting space of another device. For example, the conductive grounding layer 101 may be in a rectangle shape. A length of a long side of the conductive grounding layer 101 may range from 250 mm to 300 mm (for example, 250 mm, 270 mm, or 300 mm). A length of a short side of the conductive grounding layer 101 may range from 100 mm to 150 mm (for example, 100 mm, 120 mm, or 150 mm). Correspondingly, a geometric center line of the first antenna array 20 may be located on a side of an intersection point (a geometric center) between diagonals of the rectangle, so that the first antenna array 20 is disposed close to a vertex of the rectangular conductive grounding layer 101. Distances e8 and e9 between the first dielectric pillar 205 and side edges that are of the conductive grounding layer 101 and that are close to the first dielectric pillar 205 may range from 10 mm to 15 mm (for example, 10 mm, 12.5 mm, or 15 mm).

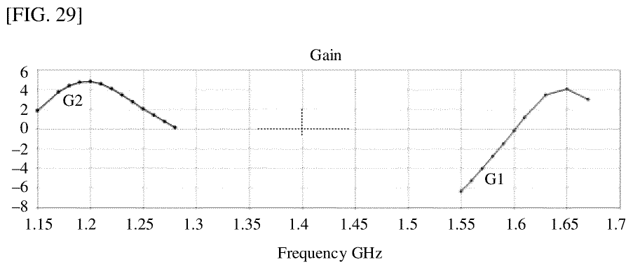

FIG. 29 is a gain diagram of the first antenna array 20 and the second antenna array 30 when the first antenna array 20 is disposed close to a vertex of the rectangular conductive grounding layer 101. In the figure, G1 is a gain curve corresponding to the second antenna array 30, and G2 is a gain curve corresponding to the first antenna array 20. It can be learned from FIG. 29 that the first antenna array 20 and the second antenna array 30 each have high gains in the L1, L2, L5, B2, and B1 frequency bands, so that the antenna assembly has high positioning precision.

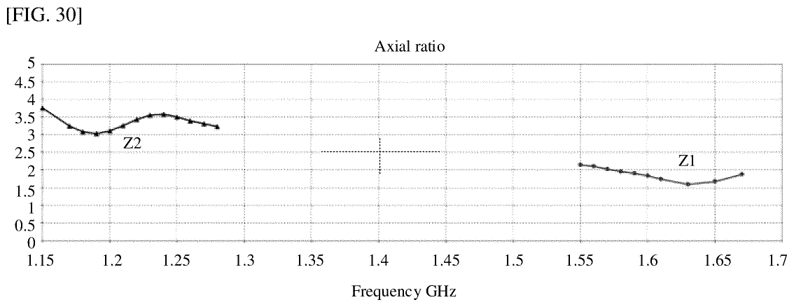

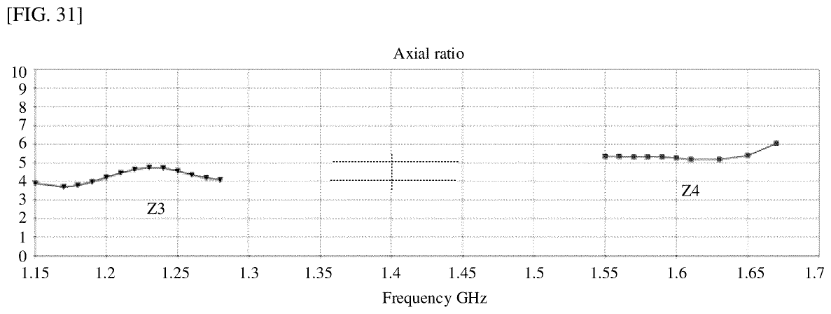

FIG. 30 is an axial ratio diagram of the first antenna array 20 and the second antenna array 30 in an axial direction (a zenith direction) when the first antenna array 20 is disposed close to a vertex of the rectangular conductive grounding layer 101. In the figure, Z1 is an axial ratio diagram corresponding to the second antenna array 30, and Z2 is an axial ratio diagram corresponding to the first antenna array 20. FIG. 31 is a maximum axial ratio diagram of the first antenna array 20 and the second antenna array 30 within ±30° in a zenith direction when the first antenna array 20 is disposed close to a vertex of the rectangular conductive grounding layer 101. In the figure, Z4 is a maximum axial ratio diagram corresponding to the second antenna array 30, and Z3 is a maximum axial ratio diagram corresponding to the first antenna array 20. It can be learned from FIG. 30 and FIG. 31 that axial ratios of the first antenna array 20 and the second antenna array 30 are both small in the L1, L2, L5, B2, and B1 frequency bands, to ensure performance of the antenna assembly.

In this scenario, the antenna assembly may further include a conductive ring 40. The conductive ring 40 may be disposed on a side that is of the first antenna array 20 and that is away from the substrate 10, to increase a gain of the antenna assembly and reduce an axial ratio of the antenna assembly, and further improve performance of the antenna assembly.

In this scenario, feed sources for feeding signals into the first antenna array 20 and the second antenna array 30 may be a same feed source or different feed sources. Feeding of the first antenna array 20 and the second antenna array 30 may be approximately the same as that in Scenario 1. Details are not described herein again.

### Scenario 3

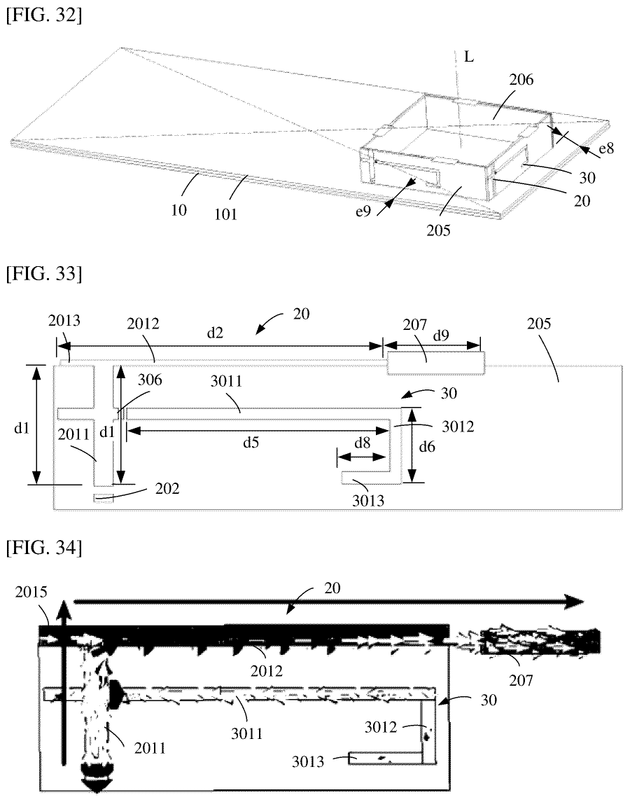

Refer to FIG. 32. In this scenario, the first antenna array 20 includes a first dielectric pillar 205. The first dielectric pillar 205 is disposed on the substrate 10, and a geometric center line of the first dielectric pillar 205 is collinear with a preset straight line L. A plurality of first antenna stubs 201 are disposed on a side wall of the first dielectric pillar 205.

For example, in an implementation in which there are four first antenna stubs 201, the first dielectric pillar 205 may be cuboid, and a projection of the first dielectric pillar 205 on the substrate may be in a square shape. Correspondingly, the first dielectric pillar 205 has four side surfaces, each side wall corresponds to one side edge of the square, and each first antenna stub 201 is disposed on one side surface.

Refer to FIG. 33. The first antenna stub 201 may include a first section 2011 extending in a direction parallel to the preset straight line L, a second section 2012 extending in a direction perpendicular to the preset straight line L, and a conductive sheet 207. The first section 2011 is located between the second section 2012 and the substrate 10. An end that is of the first section 2011 and that is close to the substrate 10 may be a first feed end. An end that is of the first section 2011 and that is away from the substrate 10 is connected to an end that is of the second section 2012 and that is close to the first section 2011. An end that is of the second section 2012 and that is away from the first section 2011 is connected to the conductive sheet 207. An end that is of the conductive sheet 207 and that is away from the second section 2012 may be used as a first open end, and the conductive sheet 207 and the conductive grounding layer 101 on the substrate 10 are spaced from each other.

In some implementations, the first antenna stub 201 further includes a third section 2013. The third section 2013 and the second section 2012 are collinearly disposed, the third section 2013 is located on a side that is of the first section 2011 and that is away from the second section 2012, and an end that is of the third section 2013 and that is close to the second section 2012 is connected to the second section 2012. The first antenna stub 201 may be tested through the third section 2013, to test the first antenna stub 201.

In the foregoing implementation, a total length of the first antenna stub 201 ranges from 40 mm to 70 mm (for example, 40 mm, 48 mm, 68 mm, or 70 mm).

For example, a length d1 of the first section 2011 may range from 10 mm to 20 mm (for example, 10 mm, 15 mm, or 20 mm), a sum of lengths d2 of the second section 2012 and the third section 2013 may range from 35 mm to 45 mm (for example, 35 mm, 40 mm, or 45 mm), and a length d9 of the conductive sheet 207 may range from 10 mm to 15 mm (for example, 10 mm, 13 mm, or 15 mm).

In the foregoing implementation, the end that is of the first section 2011 and that is close to the substrate 10 is the first feed end of the first antenna stub 201. Correspondingly, one electrode plate of the first capacitor 202 is electrically connected to the first feed end, and another electrode plate of the first capacitor 202 may be coupled to a first feed device, so that the first feed device may perform feeding on the first antenna stub 201 through the first capacitor 202.

It may be understood that the first capacitor 202 may be disposed on the first dielectric pillar 205, and the first capacitor 202 may be disposed between the first feed end and the substrate 10, to improve structural compactness of the antenna assembly.

FIG. 34 shows a distribution diagram of currents on the first antenna stub 201. In the figure, a density of arrows representing the currents is positively correlated with current amplitudes. It can be learned from FIG. 34 that the first capacitor 202 may adjust current distribution on the first antenna stub 201, so that the currents on the first antenna stub 201 are codirectional currents. In addition, amplitudes of currents on the first section 2011 and the conductive sheet 207 are small, and an amplitude of a current on the second section 2012 is large, so that the first antenna stub 201 operates in a DM mode.

Still refer to FIG. 33. In an implementation in which the antenna assembly includes a second antenna array 30, a plurality of second antenna stubs 301 are disposed on a side wall of the first dielectric pillar 205, that is, both the first antenna stub 201 and the second antenna stub 301 are disposed on the side wall of the first dielectric pillar 205. In this way, structural compactness of the antenna assembly can be improved, and a volume and mass of the antenna assembly are further reduced.

A quantity of second antenna stubs 301 may be the same as a quantity of first antenna stubs 201, and each second antenna stub 301 corresponds to one first antenna stub 201. In an implementation in which the first dielectric pillar 205 is cuboid, each second antenna stub 301 is disposed on one side surface.

The antenna assembly further includes a plurality of filter capacitors 306. A second feed end of each second antenna stub 301 is electrically coupled to a feed end of the first antenna stub 201 through one filter capacitor 306. In other words, the second antenna stub 301 is fed through the first feed end. For example, in an implementation in which the first antenna stub 201 includes the first section 2011, the second feed end of the second antenna stub 301 may be connected to the first section 2011 through a corresponding filter capacitor 306.

In some implementations, the second antenna stub 301 may include a sixth section 3011 and a seventh section 3012 that are sequentially connected to each other. The sixth section 3011 and the seventh section 3012 may be disposed between the second section 2012 and the substrate 10, and the seventh section 3012 is located between the sixth section 3011 and the substrate 10. The sixth section 3011 extends in a direction parallel to the substrate 10, and the seventh section 3012 extends in a direction parallel to the preset straight line L. An end that is of the sixth section 3011 and that is close to the first section 2011 may be the second feed end of the second antenna stub 301. The second feed end is connected to the first section 2011 through the first filter capacitor 306. An end that is of the sixth section 3011 and that is away from the first section 2011 is connected to an end that is of the seventh section 3012 and that is away from the substrate 10. In some embodiments, the second antenna stub 301 may further include an eighth section 3013. The eighth section 3013 is connected to an end of the seventh section 3012, and the eighth section 3013 is located between the seventh section 3012 and the substrate 10 and extends toward the first section 2011 in a direction parallel to the substrate 10. In some embodiments, the end of the seventh section 3012 may be a second open end of the second antenna stub 301. In an implementation in which the second antenna stub 301 includes the eighth section 3013, the eighth section 3013 may be the second open end of the second antenna stub 301. In this way, bending the second antenna stub 301 inward can reduce space occupied by the second antenna stub 301 while ensuring that the second antenna stub 301 has a specific length, so that a volume of the first dielectric pillar 205 is reduced, and miniaturization of the antenna assembly is further facilitated.

In the foregoing implementation, a total length of the second antenna stub 301 ranges from 45 mm to 55 mm (for example, 45 mm, 48 mm, or 55 mm).

For example, a length d5 of the sixth section 3011 may range from 30 mm to 40 mm (for example, 30 mm, 34.4 mm, or 40 mm), a length d6 of the seventh section 3012 may range from 5 mm to 10 mm (for example, 5 mm, 8 mm, or 10 mm), and a length d8 of the eighth section 3013 may range from 4 mm to 10 mm (for example, 4 mm, 6 mm, or 10 mm).

In this scenario, a capacitance value of the filter capacitor 306 may range from 0.1 pF to 1 pF (for example, 0.1 pF, 0.5 pF, or 1 pF). The filter capacitor 306 may filter a signal. Therefore, when the first antenna stub 201 is fed through the first feed end, currents entering the second antenna stub 301 are reduced. When the second antenna stub 301 is fed through the first feed end, the filter capacitor 306 may transmit most of currents to the second antenna stub 301. In other words, the first antenna stub 201 and the second antenna stub 301 may be fed through the first feed end separately. Correspondingly, only the first feed device needs to be disposed to perform feeding on the first antenna stub 201 and the second antenna stub 301, and a second feed device does not need to be disposed. In other words, a feed source for feeding a signal to the first antenna array 20 and the second antenna array 30 may be a same feed source, so that a structure of the system can be simplified.

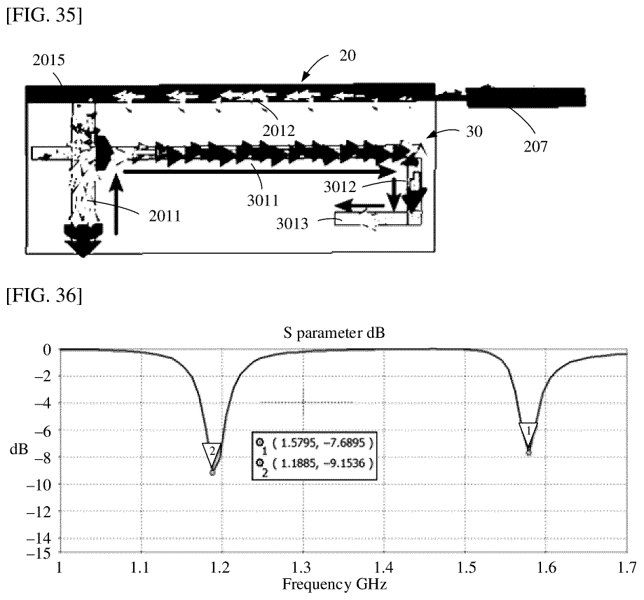

FIG. 35 shows a distribution diagram of currents on the second antenna stub 301. In the figure, a density of arrows representing the currents is positively correlated with current amplitudes. It can be learned from FIG. 35 that when the second antenna stub 301 is fed through the first feed end, the first capacitor 202 may adjust current distribution on the second antenna stub 301, so that the currents on the second antenna stub 301 are codirectional currents. In addition, an amplitude of a current on the sixth section 3011 gradually increases in a direction close to the seventh section 3012, and amplitudes of currents on the eighth section 3013 and the seventh section 3012 gradually increase in a direction close to the sixth section 3011, so that the second antenna stub 301 operates in a DM mode.

FIG. 36 is an active S11 curve diagram of the first antenna array 20 operating in a frequency band of a global satellite navigation system. A first operating frequency band of the first antenna stub 201 may be less than a second operating frequency band of the second antenna stub 301. In this case, the first antenna array 20 and the second antenna array 30 may separately excite two differential mode resonance modes. It can be learned from FIG. 36 that the antenna assembly in this case can cover L1, L5, B2, and B1 frequency bands of the global satellite navigation system.

Still refer to FIG. 32. In this scenario, the first antenna array 20 and a geometric center of the conductive grounding layer 101 may be spaced from each other, in other words, the first antenna array 20 is disposed at a position close to an edge or a corner of the conductive grounding layer 101. In this way, the antenna assembly has an irregular shape, and can adapt to irregular mounting space, to adapt to mounting space of another device. For example, the conductive grounding layer 101 may be in a rectangle shape. A length of a long side of the conductive grounding layer 101 may range from 250 mm to 300 mm (for example, 250 mm, 270 mm, or 300 mm). A length of a short side of the conductive grounding layer 101 may range from 100 mm to 150 mm (for example, 100 mm, 120 mm, or 150 mm). Correspondingly, a geometric center of the first antenna array 20 may be located on a side of an intersection point (center) between diagonals of the rectangle, so that the first antenna array 20 is disposed close to a vertex of the rectangular conductive grounding layer 101. Distances e8 and e9 between the first dielectric pillar 205 and side edges that are of the conductive grounding layer 101 and that are close to the first dielectric pillar 205 may range from 10 mm to 15 mm (for example, 10 mm, 12.5 mm, or 15 mm).

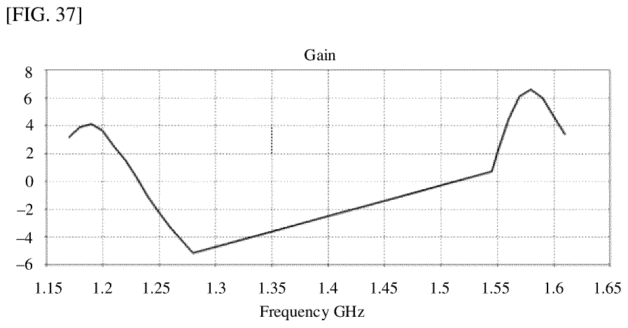

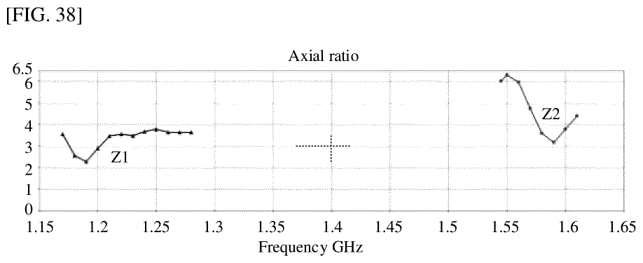

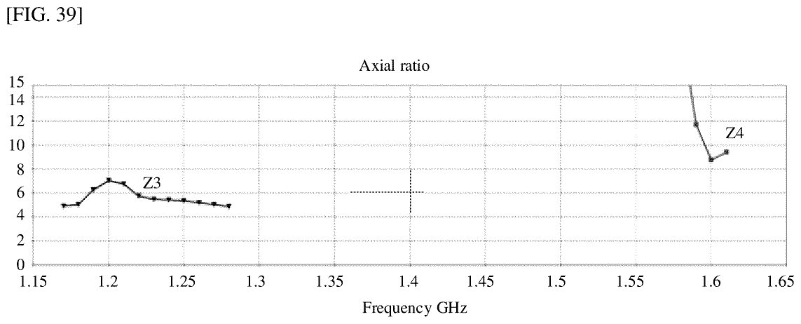

FIG. 37 is a gain diagram (indicating maximum gains within ±30° in a zenith direction) of the first antenna array 20 when the first antenna array 20 is disposed close to a vertex of the rectangular conductive grounding layer 101. It can be learned from the figure that the first antenna array 20 has a high gain in the L1, L5, B2, and B1 frequency bands, so that the antenna assembly has high positioning precision. FIG. 38 is an axial ratio diagram of the first antenna array 20 and the second antenna array 30 in an axial direction (a zenith direction) when the first antenna array 20 is disposed close to a vertex of the rectangular conductive grounding layer 101. In the figure, Z1 is an axial ratio curve corresponding to the first antenna array 20, and Z2 is an axial ratio curve corresponding to the second antenna array 30. FIG. 39 is a maximum axial ratio diagram of the first antenna array 20 and the second antenna array 30 within ±30° in a zenith direction when the first antenna array 20 is disposed close to a vertex of the rectangular conductive grounding layer 101. In the figure, Z3 is a maximum axial ratio curve corresponding to the first antenna array 20, and Z4 is a maximum axial ratio curve corresponding to the second antenna array 30. It can be learned from FIG. 37 to FIG. 39 that axial ratios of the first antenna array 20 and the second antenna array 30 are both small in the L1, L5, B2, and B1 frequency bands, to ensure performance of the antenna assembly.

### Scenario 4

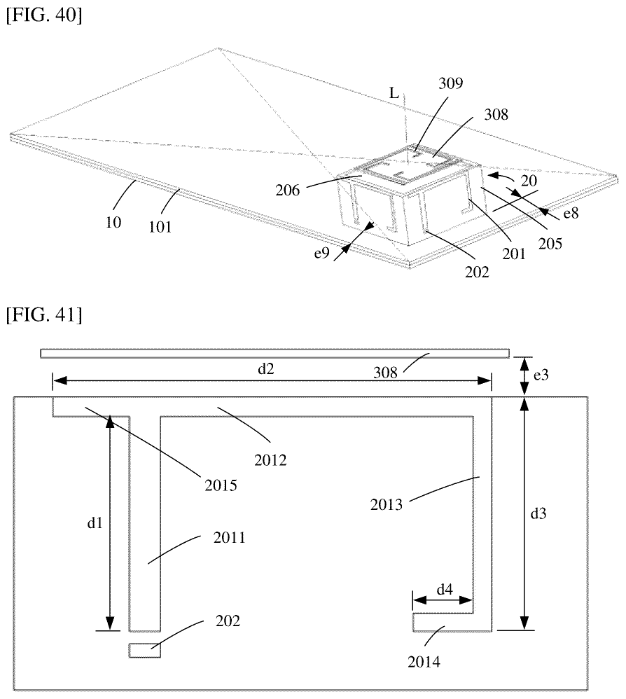

Refer to FIG. 40 and FIG. 41. A structure of a first antenna array 20 in this scenario may be approximately the same as that of the first antenna array 20 in Scenario 2. A difference lies in that a total length of the first antenna stub 201 ranges from 50 mm to 80 mm (for example, 50 mm, 54.7 mm, 74.7 mm, or 80 mm). For example, a length d1 of a first section 2011 may range from 15 mm to 20 mm (for example, 15 mm, 17 mm, or 20 mm), a sum of lengths d2 of a second section 2012 and a fifth section 2015 may range from 30 mm to 40 mm (for example, 30 mm, 34.5 mm, or 40 mm), a length d3 of a third section 2013 may range from 15 mm to 20 mm (for example, 15 mm, 18.5 mm, or 20 mm), and a length d4 of a fourth section 2014 may range from 1 mm to 10 mm (for example, 1 mm, 4.7 mm, or 10 mm).

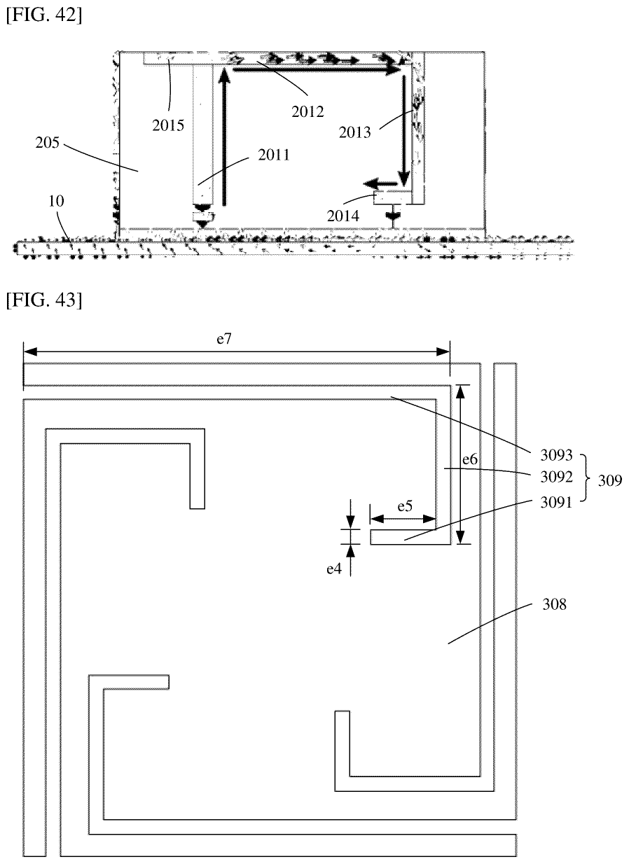

An end that is of the first section 2011 and that is away from the second section 2012 may be a first feed end of the first antenna stub 201. A first capacitor 202 is electrically connected to the first feed end, so that the first feed end is fed through the first capacitor 202. FIG. 42 shows a distribution diagram of currents on the first antenna stub 201. In the figure, a density of arrows representing the currents is positively correlated with current amplitudes. It can be learned from FIG. 42 that the first capacitor 202 may adjust current distribution on the first antenna stub 201, so that the currents on the first antenna stub 201 are codirectional currents. In addition, amplitudes of currents on the first section 2011 and the fourth section 2014 are less than an amplitude of a current on the second section 2012, so that the first antenna stub operates in a DM mode.

Refer to FIG. 40 and FIG. 43. In this scenario, the antenna assembly further includes a conductive plate 308. The conductive plate 308 and the substrate 10 are parallel to or spaced from each other. The first antenna array 20 is disposed between the conductive plate 308 and the substrate 10. A projection of the conductive plate 308 on the substrate 10 is located in an area enclosed by projections of a plurality of first antenna stubs 201 on the substrate 10. For example, the conductive plate 308 may be in a rectangle shape, a circle shape, or the like. A material of the conductive plate 308 may include a metal such as copper or aluminum. The conductive plate 308 and the first antenna array 20 are spaced from each other. For example, a distance e3 (as shown in FIG. 41) between the conductive plate 308 and the first antenna array 20 may range from 1 mm to 5 mm (for example, 1 mm, 2.5 mm, or 5 mm).

A plurality of slots 309 are provided on the conductive plate 308. Each slot 309 penetrates the conductive plate 308. Each slot 309 corresponds to one first antenna stub 201. In other words, the slots 309 are provided around the preset straight line L at equal central angles. The slot 309 extends on the conductive plate 308, so that the slot 309 and the conductive plate 308 around the slot 309 form a slot antenna. Slot antennas are disposed around the preset straight line L at equal central angles. Each slot 309 corresponds to a position of one first antenna stub 201. For example, each slot 309 is close to one first antenna stub 201, so that the first antenna stub 201 may couple a signal to the conductive plate 308. To be specific, each first antenna stub 201 may couple a signal to a slot antenna corresponding to the first antenna stub 201, so that each slot antenna generates a circular polarization signal, in other words, the conductive plate 308 generates a circular polarization signal.

In this way, the slot antenna in the conductive plate 308 and the corresponding first antenna stub 201 may be fed through a same first feed end. Correspondingly, the slot antenna and the first antenna stub 201 may be fed through only the first feed device, and a second feed device does not need to be disposed. In other words, a feed source for feeding a signal to the first antenna array 20 and the slot antenna is a same feed source. This simplifies a system structure.

Still refer to FIG. 43. In the foregoing implementation, the slot 309 may include a first slot body 3091, a second slot body 3092, and a third slot body 3093 that are sequentially connected to each other outward from the preset straight line L. The first slot body 3091 and the third slot body 3093 are provided perpendicular to a side wall of the corresponding first dielectric pillar 205. The second slot body 3092 is located between the first slot body 3091 and the third slot body 3093, and the second slot body 3092 is disposed parallel to the side wall of the corresponding first dielectric pillar 205. An end of the third slot body 3093 is connected to the outside of the conductive plate 308. For example, a width e4 of the slot 309 may range from 0.5 mm to 1.5 mm (for example, 0.5 mm, 1 mm, or 1.5 mm), a length e5 of the first slot body 3091 may range 3 mm to 8 mm (for example, 3 mm, 5 mm, or 8 mm), a length e6 of the second slot body 3092 may range 9 mm to 13 mm (for example, 9 mm, 11 mm, or 13 mm), and a length e7 of the third slot body 3093 may range from 25 mm to 35 mm (for example, 25 mm, 29.5 mm, or 35 mm).

In this way, the slot 309 is bent and extended on the conductive plate 308, so that space occupied by the slot 309 can be reduced while it is ensured that the slot 309 has a sufficient length.

In the foregoing implementation, the conductive plate 308 may be formed through electroplating, deposition, or the like, and the slot 309 on the conductive plate 308 is formed when the conductive plate 308 is formed. Certainly, after the conductive plate 308 is formed, some materials may be removed through etching, to form the slot 309.

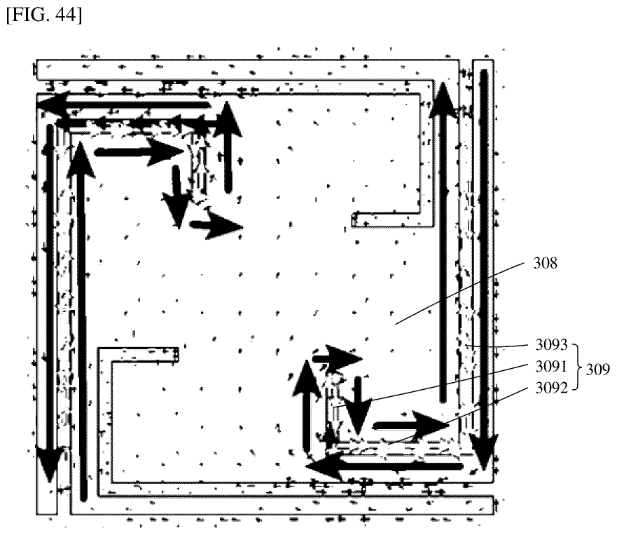

In this scenario, a first operating frequency band of the first antenna array 20 may be lower than an operating frequency of each slot antenna. FIG. 44 shows a distribution diagram of currents on each slot antenna when the first antenna stub 201 couples a signal to the conductive plate 308. In the figure, a density of arrows representing the currents is positively correlated with current amplitudes. It can be learned from FIG. 44 that an amplitude of a current on the slot 309 gradually decreases from inside to outside, so that each slot antenna operates in a common mode (common mode, CM mode for short). It can be learned from FIG. 42 and FIG. 44 that polarization directions of the first antenna array 20 and the slot antennas are the same. Compared with a case in which polarization directions of the first antenna array 20 and the slot antennas are different, a case in which polarization directions of the first antenna array 20 and the slot antennas are the same enables the antenna assembly to have a higher gain and a lower axial ratio, so that performance of the antenna assembly is improved.

It may be understood that, in a common mode antenna, current distribution on an antenna stub is as follows. Currents are codirectional, and amplitudes of the currents gradually decrease from a feed end to a ground end.

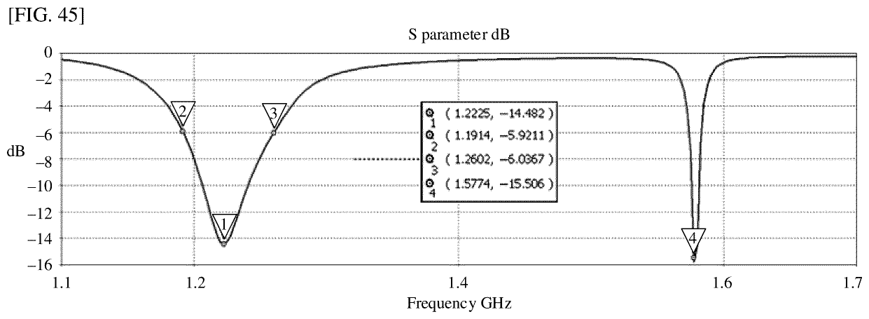

FIG. 45 is an active S11 curve diagram of the first antenna array 20 operating in a frequency band of a global satellite navigation system. A first operating frequency band of the first antenna stub 201 is less than an operating frequency of each slot antenna. At each operating frequency, the first antenna array 20 may excite differential mode resonance while each slot antenna excites common mode resonance. It can be learned from the figure that the antenna assembly in this case can cover L1, L5, L2, B2, and B1 frequency bands of the global satellite navigation system.

Still refer to FIG. 40. In this scenario, the conductive grounding layer 101 may be in a rectangle shape. A length of a long side of the conductive grounding layer 101 may range from 250 mm to 300 mm (for example, 250 mm, 271 mm, or 300 mm). A length of a short side of the conductive grounding layer 101 may range from 100 mm to 150 mm (for example, 100 mm, 120 mm, or 150 mm). Correspondingly, the first antenna array 20 and an intersection point (a geometric center) between diagonals of the rectangle may be spaced from each other, so that the first antenna array 20 is disposed close to a vertex of the rectangular conductive grounding layer 101. Distances e8 and e9 between the first dielectric pillar 205 and side edges that are of the conductive grounding layer 101 and that are close to the first dielectric pillar 205 may range from 10 mm to 15 mm (for example, 10 mm, 12.5 mm, or 15 mm).

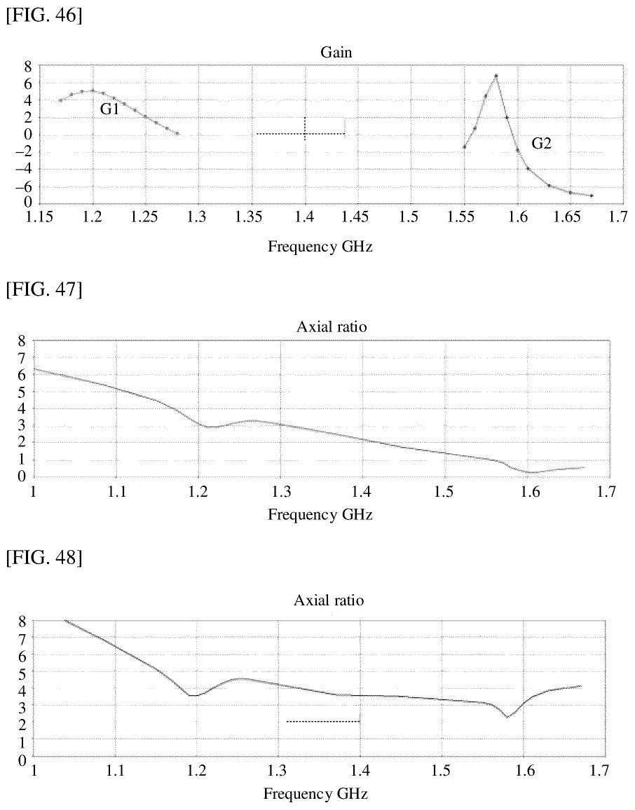

FIG. 46 is a gain diagram (within ±30° in a zenith direction) of the first antenna array 20 and each slot antenna when the first antenna array 20 is disposed close to a vertex of the rectangular conductive grounding layer 101. In the figure, G1 is a gain curve of the first antenna array 20, and G2 is a gain curve of the slot antenna. It can be learned from the figure that the first antenna array 20 and each slot antenna have high gains in the L1, L5, L2, B2, and B1 frequency bands, so that the antenna assembly has high positioning precision.

FIG. 47 is an axial ratio diagram of the first antenna array 20 in an axial direction (a zenith direction) when the first antenna array 20 is disposed close to a vertex of the rectangular conductive grounding layer 101. FIG. 48 is a maximum axial ratio diagram of the first antenna array 20 within ±30° in the zenith direction when the first antenna array 20 is disposed close to a vertex of the rectangular conductive grounding layer 101. It can be learned from FIG. 47 and FIG. 48 that the first antenna array 20 has a small axial ratio in the L1, L5, L2, B2, and B1 frequency bands, so that the antenna assembly has high performance.

### Scenario 5

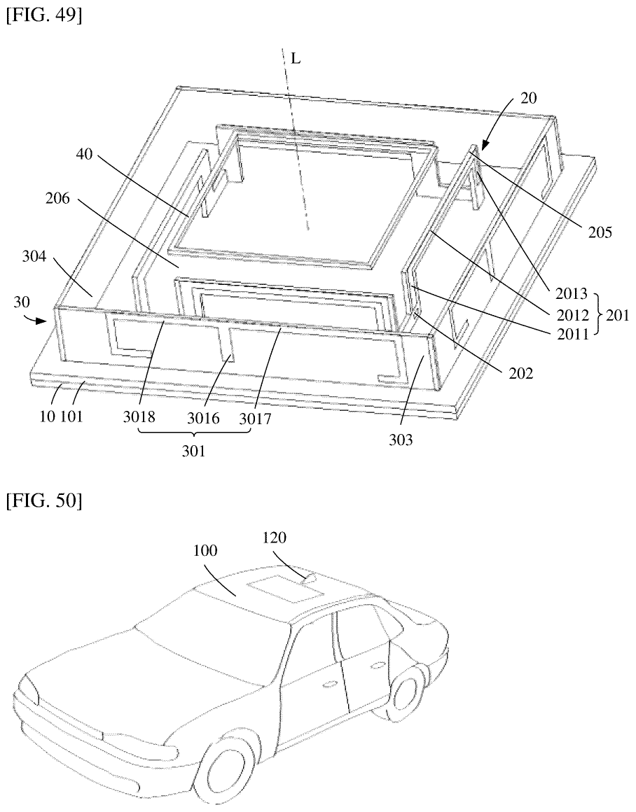

Refer to FIG. 49. In this scenario, the second antenna array 30 includes a second dielectric pillar 303. The second dielectric pillar 303 is disposed on the substrate 10, and the second dielectric pillar 303 is connected to the substrate 10. A geometric center line of the second dielectric pillar 303 and the preset straight line L may be collinearly disposed, and a plurality of second antenna stubs 301 are disposed on a side wall of the second dielectric pillar 303. For example, the second dielectric pillar 303 may be cuboid, and a projection of the second dielectric pillar 303 on the substrate 10 may be in a square shape. Correspondingly, the side wall of the second dielectric pillar 303 includes four side surfaces, and each side surface corresponds to one side of the square. There may be four second antenna stubs 301, and each second antenna stub 301 is disposed on one side surface.

Still refer to FIG. 49. The second antenna stub 301 includes a feed stub 3016, a first transverse stub 3017, and a second transverse stub 3018. The feed stub 3016 is disposed in parallel with the preset straight line L. An end that is of the feed stub 3016 and that is close to the substrate 10 may be a second feed end of the second antenna stub 301. The first transverse stub 3017 and the second transverse stub 3018 are collinearly disposed, and both the first transverse stub 3017 and the second transverse stub 3018 are disposed perpendicular to the preset straight line L. An end of the first transverse stub 3017 and an end of the second transverse stub 3018 that are close to each other are connected to an end that is of the feed stub 3016 and that is away from the substrate 10. The first transverse stub 3017 and the second transverse stub 3018 are spaced apart from the conductive grounding layer 101. During use, the feed stub 3016 may be fed through a second feed device.

As shown in FIG. 49, both the first transverse stub 3017 and the second transverse stub 3018 may bend toward the feed stub 3016, so that the first transverse stub 3017 and the second transverse stub 3018 have sufficient lengths while space occupied by the second antenna stub 301 is reduced. In this way, a volume of the antenna assembly is reduced.

A second accommodation hole 304 is provided on the second dielectric pillar 303, a center line of the second accommodation hole 304 is collinear with the preset straight line L, and the first antenna array 20 is disposed in the second accommodation hole 304. In this way, a volume of the antenna assembly can be reduced, to implement miniaturization of the antenna assembly. The first antenna array 20 may include a first dielectric pillar 205. The first dielectric pillar 205 is disposed in the second accommodation hole 304, a geometric center line of the first dielectric pillar 205 is collinear with the preset straight line L, and a plurality of first antenna stubs 201 are disposed on a side wall of the first dielectric pillar 205. In this way, the first dielectric pillar 205 is disposed in the second accommodation hole 304, so that space occupied by the first antenna array 20 can be reduced, and a volume of the antenna assembly is reduced. In addition, a center line of the first dielectric pillar 205 is collinear with the preset straight line L, so that a distance between the side wall of the first dielectric pillar 205 and a side wall of the second dielectric pillar 303 is equal everywhere. In this way, a distance between each first antenna stub 201 and each second antenna stub 301 is equal.

In the foregoing implementation, a first accommodation hole 206 is provided on the first dielectric pillar 205, and a center line of the first accommodation hole 206 is collinear with the preset straight line L. The first accommodation hole 206 is provided, so that a mass of the first dielectric pillar 205 can be reduced. In this way, a mass of the antenna assembly is reduced. It may be understood that a side wall of the first dielectric pillar 205 that is not covered by the first antenna stub 201 may be hollowed out, so that the mass of the antenna assembly may be further reduced.

In this scenario, the first dielectric pillar 205 may be cuboid, and a projection of the first dielectric pillar 205 on the substrate 10 is in a square shape. Correspondingly, the side wall of the first dielectric pillar 205 has four side surfaces, each side surface corresponds to one side of the square, and each first antenna stub 201 is disposed on one side surface. Each side surface of the first dielectric pillar 205 corresponds to one side surface of one second dielectric pillar 303, so that each first antenna stub 201 corresponds to one second antenna stub 301.

In the foregoing implementation, the first antenna stub 201 may include a first section 2011, a second section 2012, and a third section 2013. The first section 2011 and the third section 2013 are both disposed in parallel with the preset straight line L. The second section 2012 is located between the first section 2011 and the third section 2013. The second section 2012 is disposed perpendicular to the preset straight line L. An end that is of the first section 2011 and that is close to the substrate 10 may be a first feed end of the first antenna stub 201. A first capacitor 202 is connected to the first feed end. An end that is of the first section 2011 and that is away from the substrate 10 is connected to an end of the second section 2012. An end that is of the second section 2012 and that is away from the first section 2011 is connected to an end that is of the third section 2013 and that is away from the substrate 10. An end that is of the third section 2013 and that is close to the substrate 10 and the conductive grounding layer 101 are spaced from each other, and the end that is of the third section 2013 and that is close to the substrate 10 is the first open end of the first antenna stub 201.

In this scenario, operating frequencies of the first antenna stub 201 and the second antenna stub 301 are different. For example, a first operating frequency band of the first antenna stub 201 may be higher than a second operating frequency band of the second antenna stub 301. Certainly, the first operating frequency band of the first antenna stub 201 may alternatively be lower than the second operating frequency band of the second antenna stub 301.

In this scenario, the antenna assembly may further include a conductive ring 40. The conductive ring 40 may be disposed on a side that is of the first antenna array 20 and that is away from the substrate 10. The conductive ring 40 and the first antenna array 20 are spaced from each other. The first antenna stub 201 is configured to couple a signal to the conductive ring 40. During use, a direction of an induced current in the conductive ring 40 is the same as directions of currents on the first antenna stub 201 and the second antenna stub 301. In far-field performance, a codirectional superposition effect may be achieved, to increase gains of the first antenna array 20 and the second antenna array 30. In addition, a circularly polarized electromagnetic wave radiated by the conductive ring 40 is rotated in a same direction as circularly polarized electromagnetic waves radiated by the first antenna array 20 and the second antenna array 30 (for example, both are right-hand circularly polarized electromagnetic waves). A current on the conductive ring 40 and currents on the first antenna array 20 and the second antenna array 30 have a same phase change and same polarization. In this way, circular polarization radiation of the first antenna array 20 and the second antenna array 30 on the rectangular conductive grounding layer 101 is purer, and deterioration of circular polarization radiation of the first antenna array 20 and the second antenna array 30 caused by an asymmetric environment (the preset straight line L is located on a side of a center of the conductive grounding layer 101) is corrected to a specific extent. Therefore, an axial ratio of the first antenna array 20 and an axial ratio of the second antenna array 30 can be reduced.

In another implementation, the conductive ring 40 may alternatively be disposed on a side that is of the second antenna array 30 and that is away from the substrate 10. Alternatively, the conductive ring 40 is disposed on a side that is of each of the first antenna array 20 and the second antenna array 30 and that is away from the substrate 10. This is not limited in this scenario. It may be understood that in an implementation in which the conductive ring 40 is disposed on a side that is of the first antenna array 20 and that is away from the substrate 10 (that is, the conductive ring 40 is opposite to the first antenna array 20), the conductive ring 40 mainly improves performance of the first antenna array 20. In an implementation in which the conductive ring 40 is disposed on a side that is of the second antenna array 30 and that is away from the substrate 10 (that is, the conductive ring 40 is opposite to the second antenna array 30), the conductive ring 40 mainly improves performance of the second antenna array 30.

In embodiments of this application, the first antenna array 20 may be located at a geometric center of the conductive grounding layer 101, that is, the first antenna array 20 is located in a middle part of the conductive grounding layer 101, to be used in a symmetric environment. Alternatively, the first antenna array 20 and a geometric center of the conductive grounding layer 101 are spaced from each other, that is, the first antenna array 20 is located at an edge or a corner of the conductive grounding layer 101, to be used in a non-symmetric environment. Because the first antenna array 20 operates in a differential mode, the first antenna array 20 is friendly to the non-symmetric environment, and can still implement good circular polarization. In this way, the antenna assembly is ensured to have good performance.

An embodiment of this application further provides a communication device. The communication device includes the antenna assembly in the foregoing embodiments. For example, the communication device may include a telematics box, a communication base station, a mobile terminal, or the like. The communication device implements communication with another device through the antenna assembly. The communication device may include a housing. A mounting cavity is enclosed by the housing, and the antenna assembly is disposed in the mounting cavity. The antenna assembly may be fastened through the housing. In addition, the housing may protect and seal the antenna assembly.

In an implementation in which the communication device includes the telematics box, the telematics box is located on a vehicle, the vehicle includes an in-vehicle host, and the in-vehicle host is electrically connected to the telematics box. The antenna assembly may include a global navigation satellite system (an antenna, to implement BeiDou navigation satellite system navigation or global positioning system navigation. Correspondingly, the in-vehicle host may implement functions such as positioning and navigation of the vehicle through the telematics box.

As shown in FIG. 50, in another implementation, the communication device may also include a shark fin antenna 120. Correspondingly, the housing may be in a fish fin shape, the housing may be installed on a vehicle body 100 of the vehicle, and the shark fin antenna 120 is electrically connected to the in-vehicle host, so that the in-vehicle host may implement functions such as positioning and navigation of the vehicle through the shark fin antenna 120.

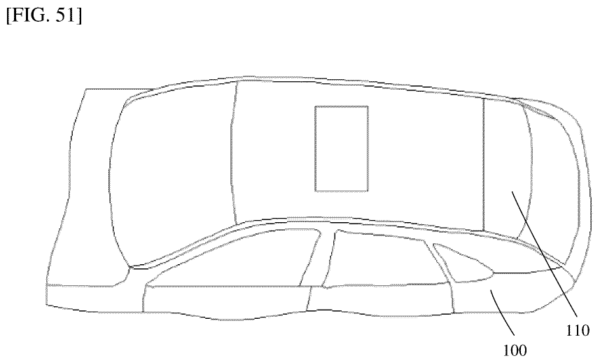

Refer to FIG. 51. An embodiment of this application further provides a vehicle. The vehicle includes a vehicle body 100 and the communication device in the foregoing embodiment. The communication device is disposed in the vehicle body 100, to implement communication between the vehicle and another external device through the communication device.

A cab and a passenger cabin are enclosed by the vehicle body 100. A driver and a co-driver are located in the passenger cabin, and another passenger is located in the passenger cabin. A rear window is disposed on the vehicle body 100 at a rear part of the passenger cabin, and a rear spoiler 110 is disposed at an upper part of the rear window. A wind resistance coefficient of the vehicle may be adjusted by the rear spoiler 110, to reduce air resistance of the vehicle.

In an implementation in which the communication device includes the telematics box, the telematics box may be disposed in the passenger cabin. Certainly, the telematics box may alternatively be disposed in the rear spoiler 110, to prevent the telematics box from occupying space in the vehicle. In addition, the rear spoiler 110 is located outside the vehicle body 100, and the telematics box is disposed in the rear spoiler 110, to prevent the metal vehicle body 100 from blocking a signal. This improves communication quality.

As shown in FIG. 50, in an implementation in which the communication device includes the shark fin antenna 120, the shark fin antenna 120 may be disposed on a top of the vehicle body 100.

The foregoing descriptions are merely specific implementations of embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An antenna assembly, comprising:
a substrate, wherein a conductive grounding layer is disposed on the substrate;
a first antenna array, wherein the first antenna array is disposed on the conductive grounding layer, wherein the first antenna array comprises a plurality of first antenna stubs, and wherein a first preset included angle is between the substrate and each plane on which one of the plurality of first antenna stub is located;
a first capacitor of a plurality of first capacitors, wherein each first antenna stub of the plurality of first antenna stubs comprises a first feed end and a first open end, wherein the first feed end and the first open end of each respective first antenna stub are two opposite ends of the respective first antenna stub in an extension direction of the respective first antenna stub, and wherein each first capacitor is coupled to the first feed end of one first antenna stub; and
a second capacitor of a plurality of second capacitors, wherein the first open end of each first antenna stub is coupled to the conductive grounding layer through one second capacitor of the plurality of second capacitors.

2. The antenna assembly according to claim 1, wherein a capacitance value of the second capacitor is within a range of 0.1 pF to 0.5 pF or a capacitance value of the first capacitor is within a range of 0.1 pF to 0.5 Pf.

3. The antenna assembly according to claim 1, wherein the antenna assembly further comprises an inductor of a plurality of inductors, wherein one end of each first capacitor of the plurality of first capacitors is electrically connected to the first feed end of one first antenna stub of the plurality of first antenna stubs, and wherein another end of each respective first capacitor is electrically connected to an end of one inductor of the plurality of inductors.

4. The antenna assembly according to claim 1, further comprising a first feed source, wherein the first feed end of each first antenna stub of the plurality of first antenna stubs is coupled to the first feed source, and wherein the plurality of first antenna stubs is configured to receive a signal of the first feed source for radiation on a first operating frequency band.

5. The antenna assembly according to claim 4, wherein signals received by first feed ends of adjacent first antenna stubs have an equal phase difference such that the first antenna array generates a circular polarization signal during operation.

6. The antenna assembly according to claim 4, wherein the antenna assembly further comprises:
a second feed source; and
a second antenna array, wherein the second antenna array is disposed on the conductive grounding layer, wherein the second antenna array comprises a plurality of second antenna stubs, wherein a second preset included angle is between the substrate and a plane on which each second antenna stub is located, wherein each second antenna stub of the plurality of second antenna stubs comprises a second feed end, wherein the second feed ends of the second antenna stubs of the plurality of second antenna stubs are all coupled to the second feed source, and the respective second antenna stub is configured to receive a signal of the second feed source for radiation on a second operating frequency band;
wherein a frequency of the first operating frequency band is different from a frequency of the second operating frequency band.

7. The antenna assembly according to claim 6, wherein the first antenna array further comprises a first dielectric pillar, wherein the first dielectric pillar is disposed on the substrate, and wherein the plurality of first antenna stubs are disposed on a side wall of the first dielectric pillar.

8. The antenna assembly according to claim 7, wherein a first accommodation hole is provided on the first dielectric pillar, wherein a geometric center line of the first dielectric pillar is collinear with a geometric center line of the first accommodation hole, and wherein the second antenna array is disposed in the first accommodation hole.

9. The antenna assembly according to claim 8, wherein each second antenna stub of the plurality of second antenna stubs corresponds to one first antenna stub of the plurality of first antenna stubs, and wherein, for each first antenna stub of the plurality of first antenna stubs and a respective second antenna stub that corresponds to the respective first antenna stub, the first feed end is disposed closer to the second feed end of the second antenna stub than the first open end and the first open end is disposed closer to a second open end of the respective second antenna stub than the second feed end.

10. The antenna assembly according to claim 9, wherein in two adjacent first antenna stubs of the plurality of first antenna stubs, wherein a first open end of a preceding first antenna stub of the plurality of first antenna stubs is disposed at a portion of the respective first antenna stub closest to the first feed end of a following first antenna stub of the plurality of first antenna stubs; and
wherein, for two adjacent second antenna stubs, a second open end of a preceding second antenna stub is disposed close to a second feed end of a following second antenna stub.

11. The antenna assembly according to claim 9, wherein each second antenna stub of the plurality of second antenna stubs corresponds to one first antenna stub of the plurality of first antenna stubs, and wherein a minimum distance between the respective first antenna stub and the respective second antenna stub that correspond to the respective first antenna stub is greater than or equal to 1 mm.

12. The antenna assembly according to claim 8, wherein each second antenna stub oof the plurality of second antenna stubs is disposed in the first accommodation hole, and wherein planes on which second antenna stubs of the plurality of second antenna stubs are located intersect at the geometric center line of the first dielectric pillar.

13. The antenna assembly according to claim 12, wherein each second antenna stub of the plurality of second antenna stubs corresponds to one first antenna stub of the plurality of first antenna stubs, and wherein, for the respective second antenna stub and the respective first antenna stub that correspond to the respective first antenna stub, the second feed end of the second antenna stub is in a portion of the second antenna stub furthest from the first antenna stub.

14. The antenna assembly according to claim 12, wherein the frequency of the first operating frequency band is less than the frequency of the second operating frequency band.

15. The antenna assembly according to claim 6, wherein the frequency of the first operating frequency band is greater than the frequency of the second operating frequency band.

16. The antenna assembly according to claim 15, wherein a difference between the frequency of the first operating frequency band and the frequency of the second operating frequency band is greater than or equal to 180 MHz.

17. The antenna assembly according to claim 6, wherein the antenna assembly further comprises a plurality of filter capacitors, and wherein the second feed end of each second antenna stub is electrically coupled to the first feed end of one first antenna stub of the plurality of first antenna stubs through one filter capacitor of the plurality of filter capacitors.

18. The antenna assembly according to claim 1, wherein the antenna assembly further comprises a conductive plate, wherein the conductive plate and the substrate are parallel to, and spaced from, each other, wherein the first antenna array is located between the conductive plate and the substrate, wherein the conductive plate and the first antenna array are spaced from each other, and wherein a projection of the conductive plate on the substrate is located in an area enclosed by projections of the plurality of first antenna stubs on the substrate; and
wherein a plurality of slots are provided on the conductive plate, wherein each slot of the plurality of slots corresponds to a position of one first antenna stub of then plurality of first antenna stubs, and wherein the first antenna stub is configured to couple a signal to the conductive plate.

19. A communication device, comprising:
a housing; and
an antenna assembly, wherein a mounting cavity is enclosed by the housing, wherein the antenna assembly is disposed in the mounting cavity;
wherein the antenna assembly comprises:
a substrate, wherein a conductive grounding layer is disposed on the substrate;
a first antenna array, wherein the first antenna array is disposed on the conductive grounding layer, wherein the first antenna array comprises a plurality of first antenna stubs, and wherein a first preset included angle is between the substrate and each plane on which each first antenna stub of the plurality of first antenna stub is located;
a first capacitor of a plurality of first capacitors, wherein each first antenna stub of the plurality of first antenna stubs comprises a first feed end and a first open end, wherein the first feed end and the first open end are two opposite ends of the respective first antenna stub in an extension direction of the respective first antenna stub, and wherein each first capacitor of the plurality of first capacitors is coupled to the first feed end of a first antenna stub of the plurality of first antenna stubs; and
a second capacitor of a plurality of second capacitors, wherein the first open end of each first antenna stub of the plurality of first antenna stubs is coupled to the conductive grounding layer through one second capacitor of the plurality of second capacitors.

20. A vehicle, comprising:
a vehicle body; and
a communication device, wherein the communication device is disposed on the vehicle body and comprises a housing and an antenna assembly, wherein a mounting cavity is enclosed by the housing, and wherein the antenna assembly is disposed in the mounting cavity;
wherein the antenna assembly comprises:
a substrate, wherein a conductive grounding layer is disposed on the substrate;
a first antenna array, wherein the first antenna array is disposed on the conductive grounding layer, wherein the first antenna array comprises a plurality of first antenna stubs, and a first preset included angle is between the substrate and each plane on which each first antenna stub of the plurality of first antenna stub is located;
a first capacitor of a plurality of first capacitors, wherein each first antenna stub of the plurality of first antenna stubs comprises a first feed end and a first open end, wherein the first feed end and the first open end are two opposite ends of the respective first antenna stub in an extension direction of the respective first antenna stub, and wherein each first capacitor of the plurality of first capacitors is coupled to the first feed end of a first antenna stub; and
a second capacitor of a plurality of second capacitors, wherein the first open end of each first antenna stub of the plurality of first antenna stubs is coupled to the conductive grounding layer through one second capacitor of the plurality of second capacitors.
